(19) United States
(12) Patent Application Publication
(10) Pub. No.: US 2006/0206550 A1
(43) Pub. Date: Sep. 14, 2006

(54) Signal measuring/analyzing apparatus and signal measuring/analyzing method

(75) Inventor: Masaharu Uchino, Aiko-gun (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Anritsu Corporation, Atsugi-shi (JP)

(21) Appl. No.: 11/365,993

(22) Filed: Mar. 1, 2006

(30) Foreign Application Priority Data
Mar. 9, 2005 (JP) 2005-065313

(51) Int. Cl. G06F 7/00

(52) U.S. Cl. 708/204

(57) ABSTRACT

A data converting unit of a signal measuring apparatus converts an input signal into digital data having a predetermined number of bits at clocks generated in a predetermined cycle ts, and performs squared detection of the digital data to output the resultant data as phase-detected data. An exponent-mantissa separator receives the phase-detected data output from the data converting unit, and separates the phase-detected data into mantissa data expressing a mantissa part of the phase-detected data and exponent data expressing an exponent part of the data to output the mantissa data and the exponent data. A mantissa calculating table is accessed by the mantissa data output from the exponent-mantissa separator, and outputs a logarithm corresponding to the mantissa data stored in advance. An exponent output unit outputs a logarithm corresponding to the exponent data based on the exponent data output from the exponent-mantissa separator. In order to obtain an output logarithm corresponding to the amplitude of the input signal, an adder adds the logarithm corresponding to the mantissa data output from the mantissa calculating table to the logarithm corresponding to the exponent data output from the exponent output unit, and outputs a logarithm depending on the phase-detected data.

### CROSS-REFERENCE TO RELATED APPLICATIONS

This application is based upon and claims the benefit of priority from prior Japanese Patent Application No. 2005-065313, filed Mar. 9, 2005, the entire contents of which are incorporated herein by reference.

### BACKGROUND OF THE INVENTION

1. Field of the Invention

The present invention relates to a signal measuring/analyzing apparatus and signal measuring/analyzing method, and more particularly, to a signal measuring/analyzing apparatus and signal measuring/analyzing method employing a technique that causes a digital circuit to perform logarithmic conversion of digital data related to a signal, a technique that interpolates data of sampling operations, and a measuring technique using these techniques in a signal measuring apparatus/method which samples a signal to convert the signal into digital data, detects the digital data, converts the digital data into a logarithm, and measures the magnitude of the logarithm and a signal analyzing apparatus/method which analyzes a probability of generating the signal and a frequency of the signal.

2. Description of the Related Art

In the conventional signal measuring/analyzing apparatus and signal measuring/analyzing method as described above, a level (power) of a signal is measured to display (output) the level in a unit of dB (decibel). For this reason, after a signal is detected by a detector, the detection output is converted into a logarithm by a log (LOG) converter using log conversion (to be also referred to as “logarithmic amplification”).

In order to perform log conversion of digital data ρ of quadrature components I and Q obtained by, for example, an IF detecting unit such as spectrum analyzer which is a kind of a signal measuring/analyzing apparatus, ρ=I²+Q² is a positive integer of 2³¹ or less when the data is expressed by a 16-bit signed integer (integer ranging from −2¹⁵ or more and 2¹⁵−1 or less). Therefore, the data is expressed by a 32-bit positive integer (integer ranging from 0 or more and 2³²−1 or less).

However, if it is assumed that the resolution of the logarithm is set at 16 bits in this case, a large amount of memory capacity corresponding to 2³¹ words is required when log conversion is simply tried to be performed. For this reason, it is problematic that the log conversion is not easily realized by an ordinary memory.

A conventional log converter is generally constituted by using analog electronic parts realized by semiconductor elements.

However, the log converter using the analog electronic parts easily has fluctuations in linearity of logarithmic conversion (log) characteristics (input-to-output characteristics of the log converter), an offset value, and the like, and problematically easily influenced by the ambient environment (see Jpn. Pat. Appln. KOKAI Publication No. 9-257843 (Patent Document 1) and Jpn. Pat. Appln. KOKAI Publication No. 7-321582 (Patent Document 2)).

In Patent Document 1, in order to make it easy to proof a device including such a log converter, a digital signal processor (DSP) which is a kind of a high-speed CPU is caused to execute a program including a procedure of a log converting process with respect to digital data generated by sampling from a signal.

In Patent Document 2, a correcting operation to convert the digital data generated by sampling into a log characteristic is performed.

According to Patent Document 1, the method is realized by software using a CPU for a high-speed operation although linearity or stability is improved. For this reason, processing time required to execute a program is so long to cause a problem.

In particular, in the method, long processing time poses a problem in an amplitude probability distribution (APD) measurement (see Jpn. Pat. Appln. KOKAI Publication No. 10-170574 (Patent Document 3)) or the like which sequentially measures an electromagnetic wave (interference wave) generated by a spectrum analyzer which measures a varying electric wave signal or an electronic device to perform a statistic process.

According to Patent Document 2, target data is corrected without using a log converter itself to obtain linearity which is a log characteristic, and thus, the corrected target data is dependent on another circuit. For this reason, correction data must be acquired for each device having a logarithmic converter to perform correction.

Since, in any of the documents described above, sampling is performed at clocks generated in a predetermined cycle ts by an analog/digital (A/D) converter to convert analog data into digital data, data between the clocks is disadvantageously dropped out.

For example, there is a spectrum analyzer which performs display such that a level of a signal having a frequency selectively received while performing frequency sweep and a receiving frequency (measured frequency) are set on an ordinate and an abscissa, respectively. In this case, when measurement display is performed in accordance with a frequency in each clock, a frequency between the clocks and data of the level corresponding to the frequency are consequently dropped out.

Even if there is an electric wave having a peak value between clocks in such a spectrum analyzer, the electric wave may not be measured.

In this case, in a conventional spectrum analyzer, measurement is performed while decreasing a frequency span of a clock unit (the frequency span is enlarged on display), so that an electric wave is captured.

However, in a method of capturing such an electric wave has a problem of long processing time required for measurement.

### BRIEF SUMMARY OF THE INVENTION

In order to solve the problems of the prior art described above, it is an object of the present invention to provide a signal measuring/analyzing apparatus and a signal measuring/analyzing method such as amplitude probability distribution measurement or a spectrum analyzer which employs a technique which can rapidly obtain a preferably log characteristic in a digitally hardware configuration by means of, for example, a logical circuit and employs a technique which calculates digital data set in a sampling interval by interpolation to minimize a memory capacity and to make it possible to perform high-speed processing.

In order to achieve the above object, the invertor of the present application has interested in an invention described in Japanese Patent No. 2920828 (Japanese Patent Application No. 10-164260 and Jpn. Pat. Appln. KOKAI Publication No. 11-337600) (Patent Document 4) in which himself has participated to try to improve the invention such that the invention can be applied to log conversion in level measurement.

In Patent Document 4, in order to measure a time interval of signals of an electromagnetic interference wave or the like directly regardless of level measurement, an electromagnetic interference wave is binarized by a predetermined threshold value, and resultant binary values are counted by a binary-coded counter to convert the values into time-series bit data. Thereafter, a logarithm is acquired.

In this case, in Patent Document 4, the logarithm is acquired to minimize wide-range time intervals ranging from a narrow time interval to a wide time interval of signals and a memory capacity and to measurement at a high speed.

The contents of Patent Document 4 are also disclosed in Non-patent Document 1 (IEEE TRANSACTIONS ON ELECTROMAGNETIC COMPATIBILITY, VOL. 43, NO. 4, NOVEMBER 2001 “Real-time Measurement of Noise Statistics”, Masaharu Uchino et al, pp. 629 to 636) and Non-patent Document 2 (EMC '99 Tokyo International Symposium On Electromagnetic Compatibility, May 1999, “SIMULTANEOUS MEASUREMENTS of DISTURBANCE APD, CRD and PDD”, Masaharu Uchino et al, pp. 177 to 180).

Therefore, in this specification, the contents disclosed in Non-patent Document 1 and Non-patent Document 2 will be referred to in relation to the contents of Patent Document 4.

In the present invention, the technique of acquiring a logarithm described in Patent Document 4 can be made possible to be applied to log conversion in level measurement of a signal by the following concrete configuration.

In order to achieve the above object, according to a first aspect of the present invention, there is provided a signal measuring apparatus comprising:

a data converting unit (100) which converts an input signal into digital data having a predetermined number of bits with clocks having a predetermined cycle ts and performs squared detection of the digital data to output the resultant data as phase-detected data;

an exponent-mantissa separator (210) which receives the phase-detected data output from the data converting unit and separates the phase-detected data into mantissa data expressing a mantissa part of the phase-detected data and exponent data expressing an exponent part of the phase-detected data to output the mantissa data and the exponent data;

a mantissa calculating table (220) which is accessed by the mantissa data output from the exponent-mantissa separator and which outputs a logarithm corresponding to the mantissa data stored in advance;

an exponent output unit (230) which outputs a logarithm corresponding to the exponent data based on the exponent data output from the exponent-mantissa separator; and

an adder (240) which, in order to obtain an output logarithm corresponding to the amplitude of the input signal, adds the logarithm corresponding to the mantissa data output from the mantissa calculating table to the logarithm corresponding to the exponent data output from the exponent output unit and outputs an output logarithm corresponding to the phase-detected data.

In order to achieve the above object, according to a second aspect of the present invention, there is provided the signal measuring apparatus according to the first aspect, wherein

the exponent output unit comprises:

an exponent calculating table (230) which is accessed by the exponent data output from the exponent-mantissa separator and which outputs a logarithm corresponding to the exponent data stored in advance.

In order to achieve the above object, according to a third aspect of the present invention, there is provided the signal measuring apparatus according to the first aspect, wherein

the exponent-mantissa separator comprises:

a decider (211) which receives the phase-detected data output from the data converting unit, discriminates a most significant bit of the phase-detected data in when receiving by using a logical circuit (211a, 211b), and outputs a discrimination result;

a mantissa selector (212) which selects data of a plurality of bits including data of a predetermined number of lower bits from the discrimination result of the most significant bit output from the decider and outputs the data as mantissa data expressing the mantissa part based on plurality of selected bit data; and

an exponent determiner (213) which converts the most significant bit into identifiable identification data based on the discrimination result of the most significant bit output from the decider and outputs the identification data as the exponent data expressing the exponent part.

In order to achieve the above object, according to a fourth aspect of the present invention, there is provided the signal measuring apparatus according to the first aspect, further comprising:

an interpolating unit (500) inserted between the data converting unit and the mantissa-exponent separator, the interpolating unit receiving the clocks having the predetermined cycle ts, interpolating the phase-detected data output from the data converting unit at an interval of 1/N in the predetermined cycle ts, and transmitting an interpolated value to the exponent-mantissa separator.

In order to achieve the above object, according to a fifth aspect of the present invention, there is provided the signal measuring apparatus according to the fourth aspect, wherein

the interpolating unit is configured to designate phase-detected data at a center (mts) of a range to be interpolated by the phase-detected data output at intervals of 1/N in the predetermined cycle ts, generate an extraction signal (mts±p, p is an integer ranging from 0 to N/2) having a cycle ts/N in the range to be interpolated, weight the phase-detected data {ρ(mts)} at the center of the range to be interpolated and nearest phase-detected data {ρ((m−1)ts), ρ((m+1)ts)} corresponding to width (±p) of a space between the extraction signal and the center in the range to be interpolated, and generate the interpolated value every extraction signal based on weighted values.

In order to achieve the above object, according to a sixth aspect of the present invention, there is provided the signal measuring apparatus according to the first aspect, wherein

the data converting unit comprises:

an analog/digital (A/D) converting unit (110) which converts the input signal into digital data having the predetermined number of bits with the clocks having the predetermined cycle ts;

a quadrature detecting unit (121) which performs a mixing operation to each component obtained by branching an output from the A/D converting unit into two components independently of two local signals having phases different from each other by 90° and each having a predetermined frequency and outputs two quadrature components having phases orthogonalized at a frequency corresponding to a difference between the frequency of the input signal and the predetermined frequency;

a resolution bandwidth (RBW) filter unit (122) which performs predetermined bandwidth limitation to the two quadrature components output from the quadrature detecting unit and outputs two bandwidth limitation resultant quadrature components;

a square detecting unit (123) which performs square detection to the two bandwidth limitation resultant quadrature components output from the RBW filter unit and outputs two square detection resultant quadrature components; and

an adding unit (124) which adds the two square detection resultant quadrature components output from the square detecting unit.

In order to achieve the above object, according to a seventh aspect of the present invention, there is provided the signal measuring apparatus according to the first aspect, further comprising:

an amplitude probability measuring unit (300),

the amplitude probability measuring unit comprising:

a memory (310) which is accessed by using the output logarithm output from the adder as an address value (k) and which outputs data corresponding to the output logarithm stored in advance to the address;

a data converter (320) which receives data {Gⁿ⁻¹(k): n is the number of times of access up to the previous access} at the address output from the memory, converts the data into data {Gⁿ(k)} including information expressing the number of times of the latest access, and stores the data at identical address in the memory;

a frequency extracting unit (330) which receives the latest data Gⁿ(k) output from the memory, converts the data into the number of times {n(k)} of access performed to addresses by the output logarithm, and outputs the number of times; and

an amplitude probability calculating unit (340) which calculates an amplitude probability based on the number of times {n(k)} of access performed by the output logarithm output from the frequency extracting unit and outputs the amplitude probability.

In order to achieve the above object, according to an eighth aspect of the present invention, there is provided a signal analyzing apparatus comprising:

an RF unit (900) which sweeps a desired frequency bandwidth to an input high-frequency (RF) signal, and thereby converts the input RF signal selectively received into a predetermined intermediate-frequency (IF) signal and outputs an IF signal;

an A/D converting unit (110) which analog/digital-converts the IF signal output from the RF unit at clocks generated in the predetermined cycle ts and outputs the digital signal as digital data having a predetermined number of bits;

an IF detecting unit (120) comprising:
a quadrature detecting unit (121) which performs a mixing operation to each component obtained by branching an output from the A/D converting unit into two components independently of two local signals having phases different from each other by 90° and each having a predetermined frequency and outputs two quadrature components having phases orthogonalized at a frequency corresponding to a difference between the frequency of the input signal and the predetermined frequency;
a resolution bandwidth (RBW) filter unit (122) which performs predetermined bandwidth limitation to the two quadrature components output from the quadrature detecting unit and outputs two bandwidth limitation resultant quadrature components;
a square detecting unit (123) which performs square detection to the two bandwidth limitation quadrature components output from the RBW filter unit and outputs two square detection resultant quadrature components; and
an adding unit (124) which adds the two square detection resultant quadrature components output from the square detecting unit and outputs phase-detected data;

a log converting unit (200) comprising:
an exponent-mantissa separator (210) which receives the phase-detected data output from the adding unit of the IF detecting unit and separates the phase-detected data into mantissa data expressing a mantissa part of the phase-detected data and exponent data expressing an exponent part of the phase-detected data to output the mantissa data and the exponent data;
a mantissa calculating table (220) which is accessed by the mantissa data output from the exponent-mantissa separator and which outputs a logarithm corresponding to the mantissa data stored in advance;
an exponent output unit (230) which outputs a logarithm corresponding to the exponent data based on the exponent data output from the exponent-mantissa separator; and
an adder (240) which adds the logarithm corresponding to the mantissa data output from the mantissa calculating table to the logarithm corresponding to the exponent data output from the exponent output unit and outputs a logarithm corresponding to the phase-detected data; and

a display control unit (400) which displays the logarithm corresponding to the phase-detected data output from the adder of the log converting unit on a display unit (600).

In order to achieve the above object, according to a ninth aspect of the present invention, there is provided the signal analyzing apparatus according to the eighth aspect, wherein

the exponent output unit comprises:

an exponent calculating table (230) which is accessed by the exponent data output from the exponent-mantissa separator and which outputs a logarithm corresponding to the exponent data stored in advance.

In order to achieve the above object, according to a tenth aspect of the present invention, there is provided the signal analyzing apparatus according to the eighth aspect, further comprising:

an amplitude probability measuring unit (300),

the amplitude probability measuring unit comprising:

a memory (310) which is accessed by using the output logarithm output from the adder of the log converting unit as an address value (k) and which outputs data corresponding to the output logarithm stored in advance to the address;

a data converter (320) which receives data {Gⁿ⁻¹(k): n is the number of times of access up to the previous access} at the address output from the memory, converts the data into data {Gⁿ(k)} including information expressing the number of times of the latest access, and stores the data at identical address in the memory;

a frequency extracting unit (330) which receives the latest data Gⁿ(k) output from the memory, converts the data into the number of times {n(k)} of access performed to addresses by the output logarithm, and outputs the number of times; and

an amplitude probability calculating unit (340) which calculates an amplitude probability of the input RF signal selectively received by the RF unit based on the number of times {n(k)} of access performed by the output logarithm output from the frequency extracting unit, and outputs the amplitude probability, wherein

the display control unit is configured to cause the display unit to selectively display the logarithm corresponding to the phase-detected data output from the adder of the log converting unit or the amplitude probability output from the amplitude probability calculating unit of the amplitude probability measuring unit on coordinates taking the abscissa of which indicates frequencies in the desired frequency bandwidth.

In order to achieve the above object, according to an eleventh aspect of the present invention, there is provided the signal analyzing apparatus according to the tenth aspect, further comprising:

an interpolating unit (500) inserted between the IF detecting unit and the log converting unit, the interpolating unit for receiving the clocks having the predetermined cycle ts, interpolating the phase-detected data output from the adder of the IF detecting unit at an interval of 1/N in the predetermined cycle ts, and transmitting an interpolated value to the exponent-mantissa separator of the log converting unit, wherein

the display control unit is configured to selectively display the logarithm depending on the phase-detected data output from the adder of the log converting unit or the amplitude probability output from the amplitude probability calculating unit of the amplitude probability measuring unit such that the frequencies in the desired frequency bandwidth on the abscissa are displayed by any of frequencies corresponding to an interval of the predetermined cycle ts and frequencies corresponding to an interval of a cycle ts/N.

In order to achieve the above object, according to a twelfth aspect of the present invention, there is provided the signal analyzing apparatus according to the eleventh aspect, wherein

the display control unit is configured to selectively display the logarithm corresponding to the phase-detected data output from the adder of the log converting unit or the amplitude probability output from the amplitude probability calculating unit of the amplitude probability measuring unit such that the frequencies in the desired frequency bandwidth on the abscissa are displayed by frequencies corresponding to an interval of the predetermined cycle ts and some of the frequencies are magnified and displayed by the frequencies corresponding to the interval of the cycle ts/N.

In order to achieve the above object, according to a thirteenth aspect of the present invention, there is provided the signal analyzing apparatus according to the eleventh aspect, wherein

the interpolating unit is configured to designate phase-detected data at a center (mts) of a range to be interpolated by the phase-detected data output at intervals of 1/N in the predetermined cycle ts, generate an extraction signal (mts±p, p is an integer ranging from 0 to N/2) having a cycle ts/N in the range to be interpolated, weight the phase-detected data {ρ(mts)} at the center of the range to be interpolated and nearest phase-detected data {ρ((m−1)ts), ρ((m+1)ts)} corresponding to width (±p) of a space between the extraction signal and the center in the range to be interpolated, and generate the interpolated value every extraction signal based on weighted values.

In order to achieve the above object, according to a fourteenth aspect of the present invention, there is provided the signal analyzing apparatus according to the eighth aspect, wherein

the exponent-mantissa separator comprises:

a decider (211) which receives the phase-detected data output from the adding unit of the IF detecting unit, discriminates a most significant bit of the received phase-detected data in when receiving by using a logical circuit (211a, 211b), and outputs a discrimination result;

a mantissa selector (212) which selects data of a plurality of bits including data of a predetermined number of lower bits from the discrimination result of the most significant bit output from the decider and outputs the data as mantissa data expressing the mantissa part based on plurality of selected bit data; and

an exponent determiner (213) which converts the most significant bit into identifiable identification data based on the discrimination result of the most significant bit output from the decider and outputs the identification data as exponent data expressing the exponent part.

In order to achieve the above object, according to a fifteenth aspect of the present invention, there is provided a signal measuring method comprising the steps of:

preparing a data converting unit (100), an exponent-mantissa separator (210), a mantissa calculating table (220), an exponent output unit (230), and an adder (240);

causing the data converting unit to convert an input signal into digital data having a predetermined number of bits at clocks having a predetermined cycle ts and to perform squared detection of the digital data to output phase-detected data;

causing the exponent-mantissa separator to receive the phase-detected data and to separate the phase-detected data into mantissa data expressing a mantissa part of the phase-detected data and exponent data expressing an exponent part of the phase-detected data to output the mantissa data and the exponent data;

outputting an output logarithm corresponding to the mantissa data stored in advance from the mantissa calculating table to be accessed by the mantissa data;

causing the exponent output unit to output a logarithm corresponding to the exponent data based on the exponent data output from the exponent-mantissa separator; and

causing the adder to, in order to obtain an output logarithm corresponding to the amplitude of the input signal, add the logarithm corresponding to the mantissa data to the logarithm corresponding to the exponent data and output an output logarithm corresponding to the phase-detected data.

In order to achieve the above object, according to a sixteenth aspect of the present invention, there is provided the signal measuring method according to the fifteenth aspect, wherein

the exponent output unit comprises:

an exponent calculating table (230) which is accessed by the exponent data output from the exponent-mantissa separator and which outputs a logarithm corresponding to the exponent data stored in advance.

In order to achieve the above object, according to a seventeenth aspect of the present invention, there is provided the signal measuring method according to the fifteenth aspect, wherein

the exponent-mantissa separator comprises:

a decider (211) which receives the phase-detected data output from the data converting unit, discriminates a most significant bit of the phase-detected data in when receiving by using a logical circuit (211a, 211b), and outputs a discrimination result;

a mantissa selector (212) which selects data of a plurality of bits including data of a predetermined number of lower bits from the discrimination result of the most significant bit output from the decider and outputs the data as mantissa data expressing the mantissa part based on the plurality of selected bit data; and

an exponent determiner (213) which converts the most significant bit into identifiable identification data based on the discrimination result of the most significant bit output from the decider and outputs the identification data as exponent data expressing the exponent part.

In order to achieve the above object, according to an eighteenth aspect of the present invention, there is provided the signal measuring method according to the fifteenth aspect, further comprising the steps of:

preparing an interpolating unit (500); and

causing the interpolating unit to receive the clocks having the predetermined cycle ts, interpolate the phase-detected data output from the data converting unit at an interval of 1/N in the predetermined cycle ts, and transmit an interpolated value to the exponent-mantissa separator.

In order to achieve the above object, according to a nineteenth aspect of the present invention, there is provided the signal measuring method according to the eighteenth aspect, wherein

the interpolating unit is configured to designate phase-detected data at a center (mts) of a range to be interpolated by the phase-detected data output at intervals of 1/N in the predetermined cycle ts, generate an extraction signal (mts±p, p is an integer ranging from 0 to N/2) having a cycle ts/N in the range to be interpolated, weight the phase-detected data {ρ(mts)} at the center of the range to be interpolated and nearest phase-detected data {ρ((m−1)ts), ρ((m+1)ts)} corresponding to width (±p) of a space between the extraction signal and the center in the range to be interpolated, and generate the interpolated value every extraction signal based on a weighted values.

In order to achieve the above object, according to a twentieth aspect of the present invention, there is provided the signal measuring method according to the fifteenth aspect, wherein

the data converting unit comprises:

an analog/digital (A/D) converting unit (110) which converts the input signal into digital data having the predetermined number of bits with clocks having the predetermined cycle ts;

a quadrature detecting unit (121) which performs a mixing operation to each component obtained by branching an output from the A/D converting unit into two components independently of two local signals having phases different from each other by 90° and each having a predetermined frequency and outputs two quadrature components having phases orthogonalized at a frequency corresponding to a difference between the frequency of the input signal and the predetermined frequency;

a resolution bandwidth (RBW) filter unit (122) which performs predetermined bandwidth limitation to the two quadrature components output from the quadrature detecting unit and outputs two bandwidth limitation resultant quadrature components;

a square detecting unit (123) which performs square detection to the two quadrature components output from the RBW filter unit and outputs two square detection resultant quadrature components; and

an adding unit (124) which adds the two square detection quadrature components output from the square detecting unit.

In order to achieve the above object, according to a twenty-first aspect of the present invention, there is provided the signal measuring method according to the fifteenth aspect, further comprising the steps of:

preparing an amplitude probability measuring unit (300) comprising a memory (310), a data converter (320), a frequency extracting unit (330), and an amplitude probability calculating unit (340);

outputting data corresponding to the output logarithm stored in advance to the address from the memory which is accessed by using the output logarithm output from the adder as an address value (k);

causing the data converter to receive data {Gⁿ⁻¹(k): n is the number of times of access up to the previous access} at the address output from the memory, convert the data into data {Gⁿ(k)} including information expressing the number of times of the latest access, and store the data at identical address in the memory;

causing the frequency extracting unit to receive the latest data Gⁿ(k) output from the memory and convert the data into the number of times {n(k)} of access performed to addresses by the output logarithm to output the number of times; and

causing the amplitude probability calculating unit to calculate an amplitude probability based on the number of times {n(k)} of access performed by the output logarithm and output the amplitude probability.

In order to achieve the above object, according to a twenty-second aspect of the present invention, there is provided a signal analyzing method comprising the steps of:

preparing a high-frequency (RF) unit (900), an analog/digital (A/D) converting unit (110), an IF detecting unit (120), a log converting unit (200), a display unit (600), and a display control unit (400);

causing the RF unit to sweep a desired frequency bandwidth to an input high-frequency (RF) signal, and thereby to convert the input RF signal selectively received into a predetermined intermediate-frequency (IF) signal and output the IF signal;

causing the A/D converting unit to analog/digital-convert the IF signal with the clocks having the predetermined cycle ts and output digital data having a predetermined number of bits;

preparing the IF detecting unit (120) comprising a quadrature detecting unit (121), a resolution bandwidth (RBW) filter unit (122), a square detecting unit (123), and an adding unit (124);

causing the quadrature detecting unit to perform a mixing operation to each component obtained by branching an output from the A/D converting unit into two components independently of two local signals having phases different from each other by 90° and each having a predetermined frequency and output two quadrature components having phases orthogonalized at a frequency corresponding to a difference between the frequency of the input signal and the predetermined frequency;

causing the RBW filter unit to perform predetermined bandwidth limitation to the two quadrature components and output two bandwidth limitation resultant quadrature components;

causing the square detecting unit to perform square detection to the two quadrature components subjected to the bandwidth limitation and output two square detection resultant quadrature components;

causing the adding unit to add the two square detection resultant quadrature components output from the square detecting unit and output phase-detected data;

preparing the log converting unit (200) comprising an exponent-mantissa separator (210), a mantissa calculating table (220), an exponent output unit (230), and an adder (240);

causing the exponent-mantissa separator to receive the phase-detected data and separate the phase-detected data into mantissa data expressing a mantissa part of the phase-detected data and exponent data expressing an exponent part of the data and output the mantissa data and the exponent data;

outputting a logarithm corresponding to the mantissa data stored in advance from the mantissa calculating table which is accessed by the mantissa data;

causing the exponent output unit to output a logarithm corresponding to the exponent data based on the exponent data;

causing the adder to add the logarithm corresponding to the mantissa data output from the mantissa calculating table to the logarithm corresponding to the exponent data output from the exponent output unit and output an output logarithm corresponding to the phase-detected data; and

causing the display control unit to display the output logarithm corresponding to the phase-detected data on the display unit.

In order to achieve the above object, according to a twenty-third aspect of the present invention, there is provided the signal analyzing method according to the twenty-second aspect, wherein

the exponent output unit comprises:

an exponent calculating table (230) which is accessed by the exponent data output from the exponent-mantissa separator and which outputs a logarithm corresponding to the exponent data stored in advance.

In order to achieve the above object, according to a twenty-fourth aspect of the present invention, there is provided the signal analyzing method according to the twenty-second aspect, further comprising the steps of:

preparing an amplitude probability measuring unit (300) comprising a memory (310), a data converter (320), a frequency extracting unit (330), and an amplitude probability calculating unit (340);

outputting data corresponding to the output logarithm stored in advance to the address from the memory which is accessed by using the output logarithm as an address value (k);

causing the data converter to receive data {Gⁿ⁻¹(k): n is the number of times of access up to the previous access} at the address output from the memory, convert the data into data {Gⁿ(k)} including information expressing the number of times of the latest access, and store the data at identical address in the memory;

causing the frequency extracting unit to receive the latest data Gⁿ(k) output from the memory, convert the data into the number of times {n(k)} of access performed to addresses by the output logarithm, and output the number of times; and

causing the amplitude probability calculating unit to calculate an amplitude probability based on the output of the number of times {n(k)} of access performed by the output logarithm.

In order to achieve the above object, according to a twenty-fifth aspect of the present invention, there is provided the signal analyzing method according to the twenty-fourth aspect, further comprising the steps of:

preparing an interpolating unit (500);

causing the interpolating unit to receive the clocks having the predetermined cycle ts, interpolate the phase-detected data output from the data converting unit at an interval of 1/N in the predetermined cycle ts, and transmit an interpolated value to the exponent-mantissa separator; and

causing the display control unit to selectively display the logarithm corresponding to the phase-detected data or the amplitude probability such that the frequencies in the desired frequency bandwidth on the abscissa are displayed by any of frequencies corresponding to an interval of the predetermined cycle ts and frequencies corresponding to an interval of a cycle ts/N.

In order to achieve the above object, according to a twenty-sixth aspect of the present invention, there is provided the signal analyzing method according to the twenty-fifth aspect, wherein

the display control unit is configured to selectively display the logarithm corresponding to the phase-detected data or the amplitude probability such that the frequencies in the desired frequency bandwidth on the abscissa are displayed by frequencies corresponding to an interval of the predetermined cycle ts and some of the frequencies are magnified and displayed by the frequencies corresponding to the interval of the cycle ts/N.

In order to achieve the above object, according to a twenty-seventh aspect of the present invention, there is provided the signal analyzing method according to the twenty-fifth aspect, wherein

the interpolating unit is configured to designate phase-detected data at a center (mts) of a range to be interpolated by the phase-detected data output at intervals of 1/N in the predetermined cycle ts, generate an extraction signal (mts±p, p is an integer ranging from 0 to N/2) having a cycle ts/N in the range to be interpolated, weight the phase-detected data {ρ(mts)} at the center of the range to be interpolated and nearest phase-detected data {ρ((m−1)ts), ρ((m+1)ts)} corresponding to width (±p) of a space between the extraction signal and the center in the range to be interpolated, and generate the interpolated value every extraction signal based on weighted values.

In order to achieve the above object, according to a twenty-eighth aspect of the present invention, there is provided the signal analyzing method according to the twenty-second aspect, wherein

the exponent-mantissa separator comprises:

a decider (211) which receives the phase-detected data output from the adding unit of the IF detecting unit, discriminates a most significant bit of the received phase-detected data by a logical circuit (211a, 211b), and outputs a discrimination result;

a mantissa selector (212) which selects data of a plurality of bits including data of a predetermined number of lower bits from the discrimination result of the most significant bit output from the decider and outputs the data as mantissa data expressing the mantissa part based on plurality of selected bit data; and

an exponent determiner (213) which converts the most significant bit into identifiable identification data based on the discrimination result of the most significant bit output from the decider and outputs the identification data as exponent data expressing the exponent part.

According to the signal measuring/analyzing apparatuses and the signal measuring/analyzing methods of the first to twenty-eighth aspects of the present invention configured as described above, the amplitude of an input signal can be rapidly measured by a hardware configuration such as a logical circuit at a preferably log characteristic with a minimum memory capacity, and data can be calculated while interpolating digital data set in a sampling interval. For this reason, the present invention has the advantages that omissions in measurement caused by sampling intervals can be reduced.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram shown to explain an overall functional configuration of a signal measuring apparatus according to a first embodiment of the present invention;

FIG. 2 is a block diagram shown to explain a configuration of a log converting unit 200 for use in the signal measuring apparatus in FIG. 1;

FIG. 3 is a block diagram shown to explain a configuration of a decider 211 in FIG. 2;

FIG. 4A is a block diagram shown to explain a 2-bit deciding circuit as a logical circuit constituting the decider 211 in FIG. 3;

FIG. 4B is a diagram showing a logical value table of the 2-bit deciding circuit in FIG. 4A;

FIG. 4C is a block diagram shown to explain a 4-bit deciding circuit as a configuration of the logical circuit constituting the decider 211 in FIG. 3;

FIG. 5 is a block diagram shown to explain a configuration related to interpolation of data as a main configuration of a signal measuring apparatus according to a second embodiment of the present invention;

FIGS. 6A, 6B, and 6C are diagrams for explaining modes of data interpolation performed by the signal measuring apparatus in FIG. 5;

FIG. 7 is a block diagram shown to explain a configuration of an interpolating unit 500 for use in the signal measuring apparatus in FIG. 5;

FIG. 8A is a block diagram of a main part shown to explain an application of the first embodiment;

FIG. 8B is an amplitude probability distribution (APD) characteristic diagram shown to explain an application of the first embodiment;

FIG. 9 is a block diagram for explaining a configuration of an amplitude probability measuring (APD) unit 300 in FIG. 1;

FIG. 10 is a block diagram shown to explain an overall functional configuration of a signal measuring apparatus according to a third embodiment of the present invention;

FIG. 11 is a graph for explaining a display according to the third embodiment of the present invention;

FIG. 12 is a graph showing an output (display) from an amplitude probability measuring (APD) unit 300 according to the third embodiment of the present invention;

FIG. 13 is a table showing logical values obtained by the decider 211 in FIG. 2; and

FIG. 14 is a block diagram showing a configuration of another example of the log converting unit 200 in FIG. 1.

### DETAILED DESCRIPTION OF THE INVENTION

Reference will now be made in detail to the embodiments of the invention as illustrated in the accompanying drawings, in which like reference numerals designate like or corresponding parts.

Embodiments of a signal measuring/analyzing apparatus and a signal measuring/analyzing method according to the present invention will be described below with reference to the accompanying drawings.

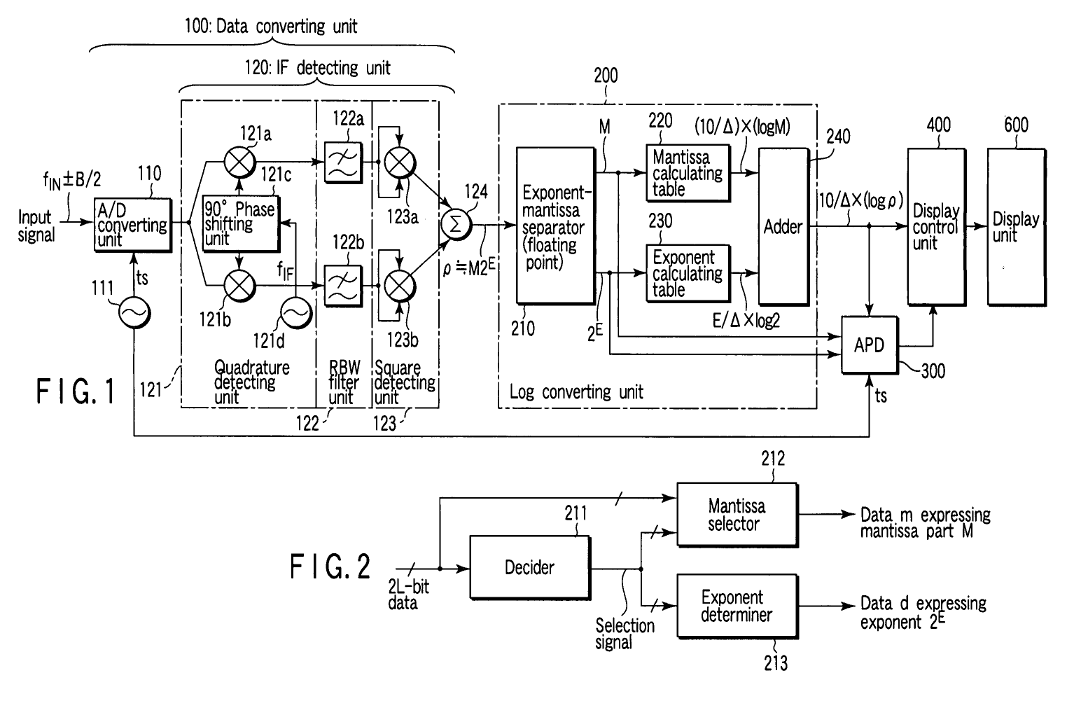

A signal measuring apparatus according to the present invention, basically, as shown in FIG. 1, has a data converting unit 100, an exponent-mantissa separator 210, a mantissa calculating table 220, an exponent output unit 230, and an adder 240. The data converting unit 100 converts an input signal into digital data having a predetermined number of bits with clocks having a predetermined cycle ts, and performs squared detection of the digital data to output the resultant data as phase-detected data. The exponent-mantissa separator 210 receives the phase-detected data output from the data converting unit 100, and separates the phase-detected data into mantissa data expressing a mantissa part of the phase-detected data and exponent data expressing an exponent part of the phase-detected data to output the mantissa data and the exponent data. The mantissa calculating table 220 is accessed by the mantissa data output from the exponent-mantissa separator 210 and outputs a logarithm corresponding to the mantissa data stored in advance. The exponent output unit 230 outputs a logarithm corresponding to the exponent data based on the exponent data output from the exponent-mantissa separator 210. In order to obtain an output logarithm corresponding to the amplitude of the input signal, the adder 240 adds the logarithm corresponding to the mantissa data output from the mantissa calculating table 220 to the logarithm corresponding to the exponent data output from the exponent output unit 230, and outputs an output logarithm corresponding the phase-detected data.

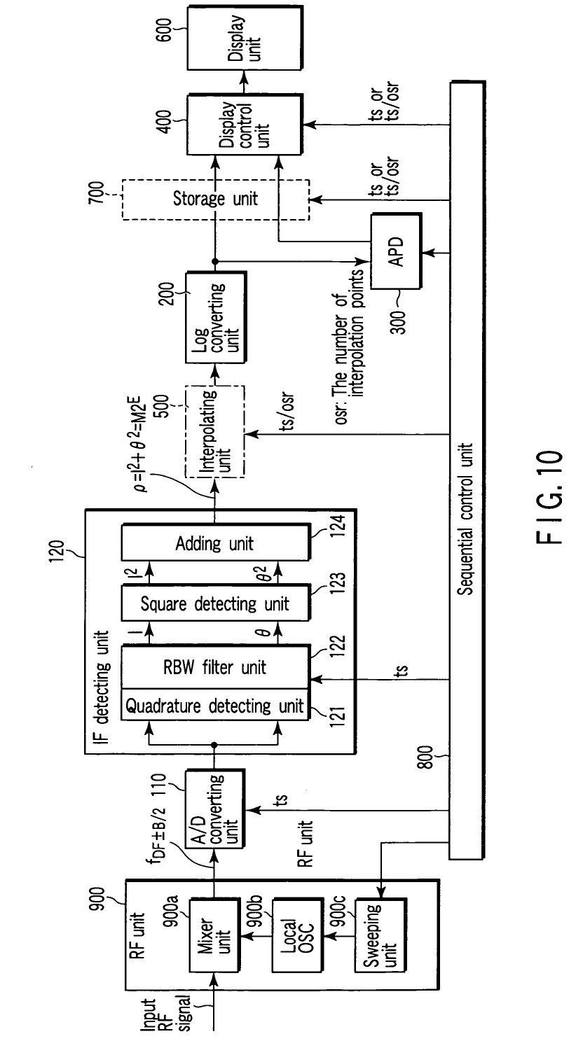

A signal analyzing apparatus according to the present invention, basically, as shown in FIG. 10, has an RF unit 900, an analog/digital (A/D) converting unit 110, an IF detecting unit 120, a log converting unit 200, and a display control unit 400. The RF unit 900 sweeps a desired frequency bandwidth to an input high-frequency (RF) signal, and thereby converts the input RF signal selectively received into a predetermined intermediate-frequency (IF) signal and outputs the IF signal. The A/D converting unit 110 analog/digital-converts the IF signal output from the RF unit 900 with the clocks having the predetermined cycle ts, and outputs digital data having a predetermined number of bits. The display control unit 400 displays a logarithm corresponding to the phase-detected data output from the log converting unit on a display unit 600.

The IF detecting unit 120 has a quadrature detecting unit 121, a resolution bandwidth (RBW) filter unit 122, a square detecting unit 123, and an adding unit 124. The quadrature detecting unit 121 performs a mixing operation to each component obtained by branching the digital data output from the A/D converting unit into two components independently of two local signals having phases different from each other by 90° and each having a predetermined frequency, and outputs two quadrature components having phases orthogonalized at a frequency corresponding to a difference between the frequency of the input RF signal and the predetermined frequency. The RBW filter unit 122 performs predetermined bandwidth limitation to the two quadrature components output from the quadrature detecting unit 121, and outputs the two bandwidth limitation resultant quadrature components. The square detecting unit 123 performs square detection to the two bandwidth limitation resultant quadrature components output from the resolution bandwidth (RBW) filter unit 122, and outputs the square detection resultant quadrature components. The adding unit 124 adds the two square detection resultant quadrature components output from the square detecting unit 123, and outputs phase-detected data.

The log converting unit 200 has an exponent-mantissa separator 210, a mantissa calculating table 220, an exponent output unit 230, and an adder 240. The exponent-mantissa separator 210 receives the phase-detected data output from the adding unit 124 of the IF detecting unit 120, and separates the phase-detected data into mantissa data expressing a mantissa part of the phase-detected data and exponent data expressing an exponent part of the data to output the mantissa data and the exponent data. The mantissa calculating table 220 is accessed by the mantissa data output from the exponent-mantissa separator 210 and outputs a logarithm corresponding to the mantissa data stored in advance. The exponent output unit 230 outputs a logarithm corresponding to the exponent data based on the exponent data output from the exponent-mantissa separator 210. The adder 240 adds the logarithm corresponding to the mantissa data output from the mantissa calculating table 220 to the logarithm corresponding to the exponent data output from the exponent output unit 230, and outputs a logarithm depending on the phase-detected data.

A signal measuring method according to the present invention, basically, as shown in FIG. 1, has: a step of preparing a data converting unit 100, an exponent-mantissa separator 210, a mantissa calculating table 220, an exponent output unit 230, and an adder 240; a step of causing the data converting unit 100 to convert an input signal into digital data having a predetermined number of bits at clocks having in a predetermined cycle ts and to perform squared detection of the digital data to output the resultant data as phase-detected data; a step of causing the exponent-mantissa separator 210 to receive the phase-detected data and to separate the phase-detected data into mantissa data expressing a mantissa part of the phase-detected data and exponent data expressing an exponent part of the phase-detected data to output the mantissa data and the exponent data; a step of outputting a logarithm corresponding to the mantissa data stored in advance from the mantissa calculating table 220 to be accessed by the mantissa data; a step of causing the exponent output unit 230 to output a logarithm corresponding to the exponent data based on the exponent data output from the exponent-mantissa separator 210; and a step of causing the adder 240, in order to obtain an output logarithm corresponding to the amplitude of the input signal, to add the logarithm corresponding to the mantissa data to the logarithm corresponding to the exponent data and to output an output logarithm corresponding to the phase-detected data.

A signal analyzing method according to the present invention, basically, as shown in FIG. 10, has: a step of preparing an RF unit 900, an analog/digital (A/D) converting unit 110, an IF detecting unit 120, a log converting unit 200, a display unit 600, and a display control unit 400; a step of causing the RF unit 900 to sweep a desired frequency bandwidth to an input high-frequency (RF) signal and thereby to convert the input RF signal selectively received into a predetermined intermediate-frequency (IF) signal and output the IF signal; a step of causing the A/D converting unit 110 to analog/digital-convert the IF signal with the clocks having the predetermined cycle ts and to output digital data having a predetermined number of bits; a step of preparing the IF detecting unit 120 including a quadrature detecting unit 121, a resolution bandwidth (RBW) filter unit 122, a square detecting unit 123, and an adding unit 124; a step of causing the quadrature detecting unit 121 to perform a mixing operation of each component obtained by branching the digital data into two components independently of two local signals having phases different from each other by 90° and having different predetermined frequencies and to output two quadrature components having phases orthogonalized at a frequency corresponding to a difference between the frequency of the input RF signal and the predetermined frequency; a step of causing the RBW filter unit 122 to perform predetermined bandwidth limitation to the two quadrature components and to output the resultant quadrature components; a step of causing the square detecting unit 123 to perform square detection to the two quadrature components subjected to the bandwidth limitation and to output the resultant quadrature components; a step of causing the adding unit 124 to add the two quadrature components output from square detecting unit and to output the additional value as phase-detected data; a step of preparing the log converting unit 200 including an exponent-mantissa separator 210, a mantissa calculating table 220, an exponent output unit 230, and an adder 240; a step of causing the exponent-mantissa separator 210 to receive the phase-detected data and to separate the phase-detected data into mantissa data expressing a mantissa part of the phase-detected data and exponent data expressing an exponent part of the data to output the mantissa data and the exponent data; a step of outputting a logarithm corresponding to the mantissa data stored in advance from the mantissa calculating table 220 to be accessed by the mantissa data; a step of causing the exponent output unit 230 to output a logarithm corresponding to the exponent data based on the exponent data; a step of causing the adder 240 to add the logarithm corresponding to the mantissa data output from the mantissa calculating table 220 to the logarithm corresponding to the exponent data output from the exponent output unit 230 and to output an output logarithm corresponding to the phase-detected data; and a step of causing the display control unit 400 to display the output logarithm corresponding to the phase-detected data on the display unit 600.

### First Embodiment

With reference to FIG. 1, configurations and operations will be described below in the order of operations from an input side to an output side.

In FIG. 1, a data converting unit 100 is constituted by an A/D converting unit 110 and an IF detecting unit 120.

The A/D converting unit 110 receives an input signal f_{IN}±B/2 (where ±B/2 is a frequency band), performs sampling at clocks generated by a clock generators 111 in a predetermined cycle ts (frequency fs, for example, 100 MHz) to convert the sampled signal into digital data having a predetermined number of bits, for example, L (=14) bits.

The two branched components of the digital data are transmitted to one inputs of mixers 121a and 121b constituting the IF detecting unit 120, respectively.

The IF detecting unit 120 is constituted by, in addition to the mixers 121a and 121b, a quadrature detecting unit 121 including a frequency generating unit 121d and a 90° phase shifter, an RBW filter unit 122, a square detecting unit 123, and an adder 124 to perform digital processing.

In the quadrature detecting unit 121, a digitized input signal f_{IN} is orthogonally detected to obtain two low-frequency signals having quadrature phases.

The frequency generating unit 121d generates a local signal f_{IF} which is a signal having a predetermined frequency which is almost equal to that of the input signal.

The 90° phase shifter 121 having received the local signal f_{IF} generates two local signals f_{IF} having quadrature phases, and transmits the two local signals f_{IF} to the other inputs of the mixers 121a and 121b, respectively.

In this manner, from the mixers 121a and 121b, I≡ sin 2πfb and Q≡ cos 2πfb (where fb=f_{IN}−f_{IF} and a frequency band is B/2) are output.

The two quadrature signals from the mixers 121a and 121b are subjected to bandwidth limitation with bandwidths (RBW) required for respective resolutions of the two quadrature signals by low-pass filters 122a and 122b of the RBW filter unit 122, so that only a necessary signal is extracted.

The low-pass filters 122a and 122b are constituted by digital filters operated in a clock cycle ts. The clock cycle is made variable to make it possible to vary a resolution bandwidth (RBW).

Two outputs extracted by the low-pass filters 122a and 122b of the RBW filter unit 122 are subjected to square detection by two square detecting units 123a and 123b of the square detecting unit 123. The two outputs subjected to square detection are output.

The adder 124 adds the square-detected outputs from the two square detecting units 123a and 123b to each other, thereby outputting an additional signal given by ρ(t)=I²+Q², i.e., consequently, 2L-bit digital data expressing a level (power) value of the input signal f_{IN} to a log converting unit 200.

The log converting unit 200 is equipped with an exponent-mantissa separator 210, a mantissa calculating table 220, an exponent calculating table 230, and an adder 240 which are constituted by hardware configurations such as digital circuits and memories, respectively.

The configuration and operation of the log converting unit 200 will be briefly described first, and the details thereof will be described later.

Digital data input from the adder 124 is 2L-bit data and is approximately expressed by, for example, β=M2^{E} and E=2L−1.

The exponent-mantissa separator 210 separates the 2L-bit data input from the adder 124 into data m expressing a mantissa part M and data d expressing an exponent part 2^{E} by using a logical circuit (to be described later).

The mantissa calculating table 220 is constituted by a memory serving as a look-up table to store a logarithm corresponding to the mantissa part M in relation to a value of the data m expressing the mantissa part M in advance. An address corresponding to the value of the data m is accessed by the exponent-mantissa separator 210, so that a logarithm 10/Δ×logM (1/Δ is a coefficient) corresponding to the data m is output.

Similarly, the exponent calculating table 230 is constituted by a memory serving as a look-up table to store a logarithm corresponding to the exponent part 2^{E} in relation to data d expressing the exponent part 2^{E} in advance. An address corresponding to the value of the data d is accessed by the exponent-mantissa separator 210, so that a logarithm E/Δ×log2 (any logarithm is a common logarithm) corresponding to the data d is output.

The adder 240 outputs a logarithm 10/Δ×logρ obtained by adding the logarithm 10/Δ×logM of the mantissa part M output from the mantissa calculating table 220 to the logarithm E/Δ×log2 of the exponent part 2^{E} output from the exponent calculating table 230.

As shown in FIG. 14, by a multiplexer 230a used in place of the exponent calculating table 230 in FIG. 1, a value “E” (exponent) serving as the data d expressing the exponent part 2^{E} may be received from the exponent-mantissa separator 210 and multiplied by a constant value log2/Δ read from a constant value storage unit 230b to output E/Δ×log2.

The exponent calculating table 230, the multiplexer 230a, and the constant value storage unit 230b constitute exponent output units according to the present invention, respectively.

A logarithm 10/Δ×logρ output from the adder 240 is displayed on the display unit 600 in units of decibels by the display control unit 400.

An amplitude probability (distribution) measuring unit (APD) 300 is a measuring unit which measures an amplitude probability (distribution) from the logarithm 10/A×logρ. As an example, the schematic configuration of the measuring unit is shown in FIG. 9.

In FIG. 9, the input data 10/A×logρ is simply represented by D. Assuming that the value corresponds to an address k in a memory 310, data is expressed by Dk.

When the memory 310 is accessed by data Dk, a data converter 320 receives data Gⁿ⁻¹(k) stored at an address k (Gⁿ⁻¹(k) is data representing the number of times of access to the address k up to the previous access) and converts the data Gⁿ⁻¹(k) into data Gⁿ(k) to restore the data Gⁿ(k) at the address k (update and record).

Every predetermined period, a frequency extracting unit 330 reads the data Gⁿ(k) from the memory 310 and extracts the number of times n(k) of access to the address k.

Since the address k represents a size of a level (since an output in log conversion, the size is expressed in units of decibels), the reference symbol n(k) is the number of times of generation of an input signal having the size (amplitude) in a predetermined period of time.

An amplitude probability calculating unit 340 observes the number of times of generation every predetermined period of time to calculate observation results as hour rates.

The APD 300 may calculates an amplitude probability (distribution) by receiving an output from the exponent-mantissa separator 210 (dotted line in FIG. 1) without an output from the adder 240 in FIG. 1.

The operation itself of the APD 300 is the same as described above. However, the number of bits of data to be processed when the output from the exponent-mantissa separator 210 is received is made smaller than the number of bits of data to be processed when the output from the adder 240 is received. For this reason, the APD 300 can be simply constructed on a scale.

With respect to the APD (amplitude probability measuring unit), more particular, a technique related to SPECTRUM ANALYZER HAVING FUNCTION OF DISPLAYING AMPLITUDE PROBABILITY DISTRIBUTION EFFECTIVELY descried in the specification of U.S. Pat. No. 6,509,728 serving as Patent Document 5 can be used.

The data G can be generated by a minimum memory capacity (to be described later) based on data conversion performed by a plurality of counting circuits corresponding to a plurality of primitive polynomials described in Patent Document 5 (U.S. Pat. No. 6,509,728).

The display control unit 400 displays data output from the APD 300 on the display unit 600 in a predetermined format.

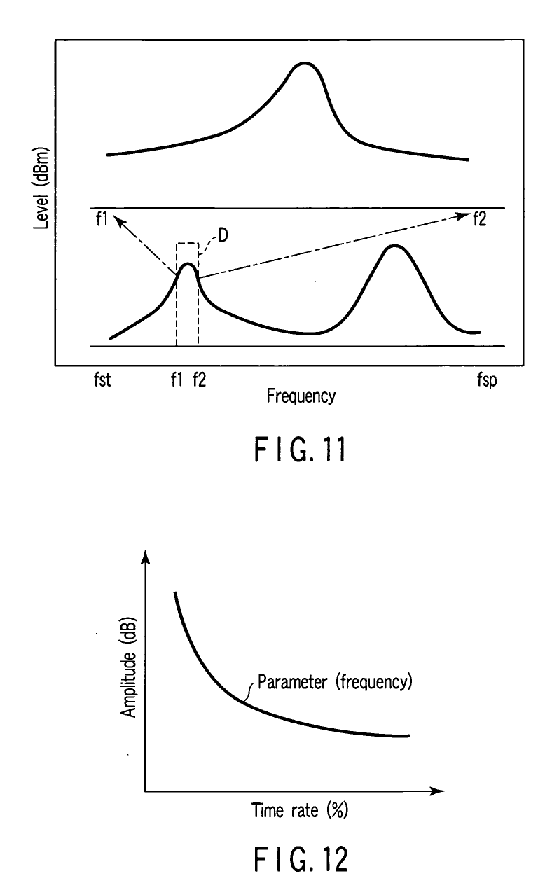

In FIG. 12 showing the display, the ordinate indicates the magnitude (decibel) of an interference wave which is an input signal, and the abscissa indicates an hour rate (%). On the coordinates, a probability distribution of the interference wave (electromagnetic wave) which is an input signal of a certain frequency component (f_{IN}).

However, when the APD 300 receives an output from the exponent-mantissa separator 210 to calculate an amplitude probability (distribution), the ordinate is linearly displayed.

(Application of First Embodiment)

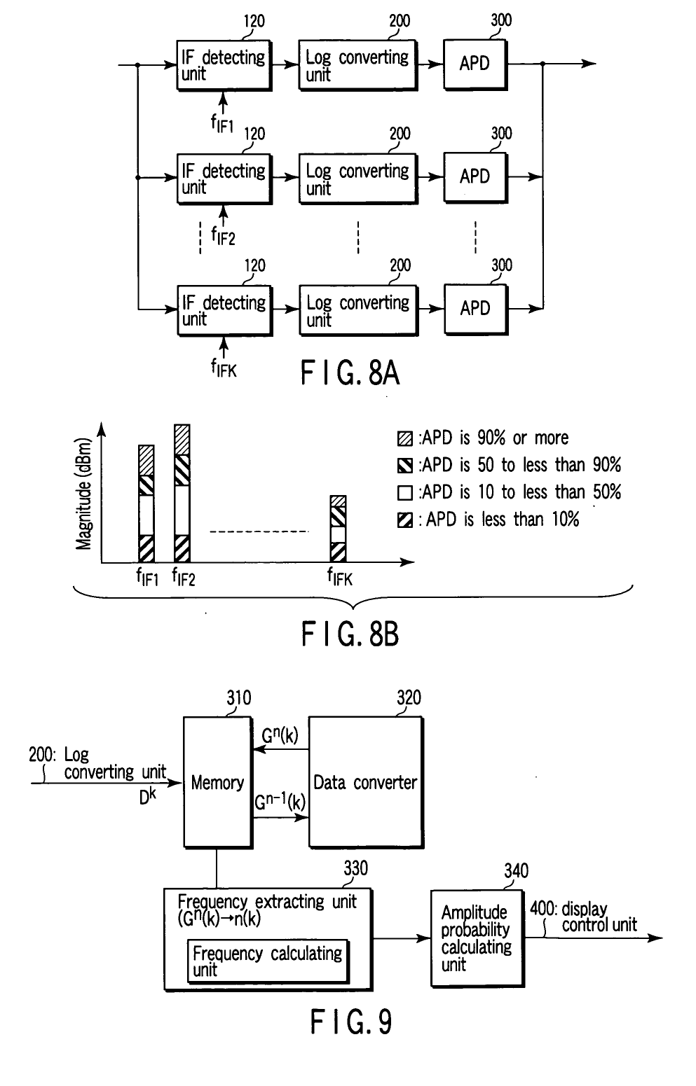

In FIG. 8A showing a configuration serving as an application of the first embodiment, a plurality (k) of series connections each constituted by the IF detecting unit 120, the log converting unit 200, and the APD 300 in FIG. 1 are connected in parallel to each other, and the frequencies of frequency generating units 12d of the IF detecting units 120 are shifted bit by bit.

It is assumed that the resolution bandwidths of RBW units 112 of the IF detecting units 120 are given by B_{RBW} and that the frequencies of the frequency generating units 12d are set at frequencies given by, for example, f_{IF1}, f_{IF2}=f_{IF1}+2B_{RBW}, f_{IF3}=f_{IF2}+2B_{RBW}, . . . , which are different from each other by 2B_{RBW} each. In this case, an amplitude probability can be measured over an input frequency range of f_{IF1} to f_{IFk}.

In FIG. 8B showing the display as the result, the ordinate indicates a signal level (dBm), the abscissa indicates a frequency, and the hour rates of APD are separately displayed in four areas of 10% or less, 10 to 50%, 50 to 90%, and 90% or more.

This display corresponds a kind of a display in which the hour rates are divisionally displayed depending on parameters in FIG. 12.

An output from the log converting unit 200 previous to the APD 300 in FIG. 8A is displayed, a spectrum over the input frequency range of f_{IF1} to f_{IFk} can be displayed.

In FIG. 8A, frequency analysis is performed by the plurality of IF detecting units 120 arranged in parallel to each other. However, the frequency analysis can also be realized by fast Fourier transformation.

Although not shown in FIG. 1, after a memory is arranged prior to the display control unit 400 to store an output from the log converting unit 200 or an output from the APD 300, the output may also be read, variously processed, and displayed.

Such a memory may be arranged prior to the log converting unit 200.

(Detailed Description of Log Converting Unit 200)

The exponent-mantissa separator 210 of the log converting unit 200 separates input data ρ into a mantissa part M and an exponent part 2^{E} to generate data m and data d respectively expressing the mantissa part M and the exponent part 2^{E}.

For this purpose, in this embodiment, the exponent-mantissa separator 210 converts input data into data in a floating-point format.

In general, 2L-bit binary-number data z is expressed in the following format (fixed point):

$$\begin{matrix}{z}_{S} = ( Q 0 \cdot {2}^{0} ) + ( Q 1 \cdot {2}^{1} ) + … + ( {Q}_{2 L - 1} \cdot {2}^{2 L - 1} ) \\ = {\sum }_{1} ( {Q}_{i} \cdot {2}^{i} )\end{matrix}$$

where i is any one of values 0 to 2L−1 (expressing a digit place of a bit); and Qᵢ is 0 or 1 (bit data expressing a place value).

The data d expressing the exponent part 2^{E} of binary-number data zₛ with respect to an actually input signal is an integer ranging from 0 to 2L−1 (2L bit), and a value which satisfies the following condition:
2^{d}≦zₛ<2^{d+1,}
and bit data Q in the data zₛ is “1” which is the most-significant place value.

When the binary-number data zₛ is expressed by the data d, the following condition is established:

$$\begin{matrix}{z}_{S} = {2}^{d} + {\sum }_{2} ( {Q}_{i} \cdot {2}^{i} ) \\ = {2}^{d} ( 1 + {\sum }_{3} ( {Q}_{d - i} \cdot {2}^{- 1} ) )\end{matrix}$$

where Σ₂ is a sum of i (i=0 to 2d−1); and Σ₃ is a sum of i (i=0 to ∞).

A significant digit used when the binary-number data zₛ is expressed in a floating-point format is set at 4 bits, i.e., up to 3 bits following “1” the most-significant digit, the binary-number data z₅ is expressed by the following equation:
zₛ=2^{d}[1+m/2³]
where m=(Q_{d-1}·2²)+(Q_{d-2}·2¹)+(Q_{d-3}−2⁰).

More specifically, by floating-point conversion, the data ρ obtained by converting a floating-point-format data constituted by r-bit data m expressing the mantissa part M and g-bit data d expressing the exponent part 2^{E} is expressed by the following equation:
ρ=zₛ=(1+m/2^{r})2^{d}.

When the data is compared with the data ρ=M2^{E} of the original input signal, the data is expressed as follows:

M: 1+m/2^{r}

E: d

More specifically, the mantissa part M and the exponent part 2^{E} can be determined based on the data m and the data d.

In the above expression, as the bit rate r of the data m expressing the mantissa part M increases, accuracy is improved. However, in fact, since the data m may falls within an allowable error range, the bit rate is satisfactorily set at 8 bits (however, in this case, the explanation will be performed on the assumption that the bit rate r is set at 3 bits).

The exponent part d sufficiently has 5 bits (=g) when the exponent E has 2L=32 bits and is expressed by a binary number.

In other words, this means that the data d is converted into a binary number which can discriminate 2L values.

As described above, in the exponent-mantissa separator 210, the data m expressing the mantissa part and the data d expressing the exponent part are separately output.

For this reason, the decider 211 decides the most-significant bit (digit) as shown in FIG. 2.

A mantissa selector 212 selects and outputs 3-bit data m following the most-significant lower digit from the data ρ, with the decision result of the decider 211 being as a selection signal.

An exponent determiner 213 generates 5-bit data d having the most-significant digit value decided by the decider 211.

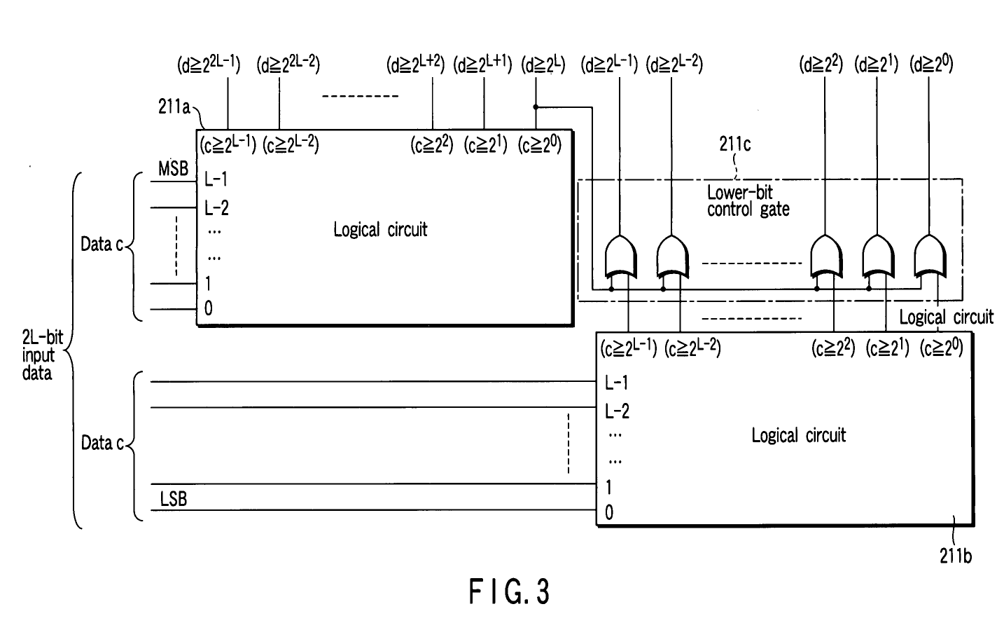

A concrete configuration of the decider 211 is shown in FIG. 3.

FIG. 3 shows a case where, if some digit has bit data “1” depending on input 2L-bit data ρ by an upper-bit deciding logical circuit 211a, a lower-bit deciding logical circuit 211b, and a lower-bit control circuit 211c, bit data of digits following the digit is set at “1”. As a result, the most-significant digit number is decided.

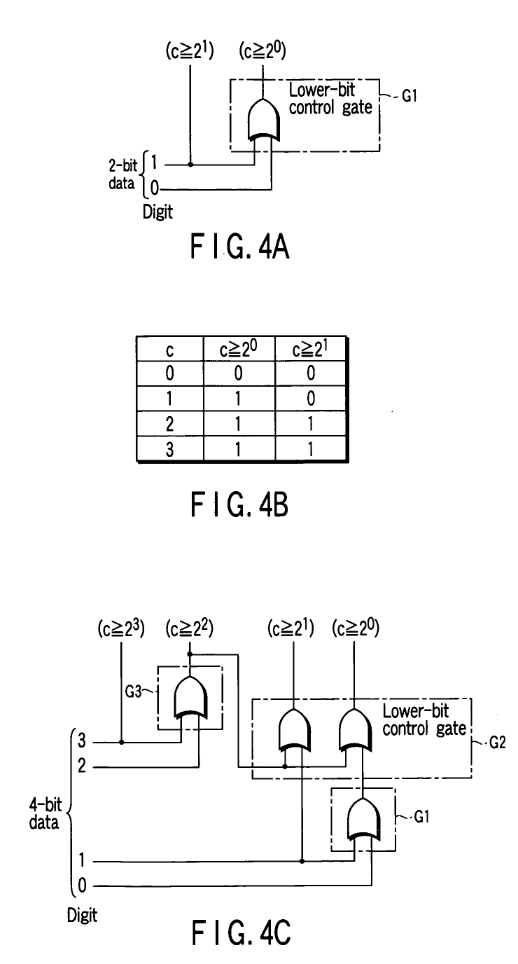

The principle in FIG. 3 will be described in advance with reference to FIGS. 4A, 4B, and 4C.

FIG. 4A is a 2-bit deciding circuit having a lower-bit control gate G1 constituted by an OR logical element, and a logical value table of the deciding circuit is shown in FIG. 4B.

FIG. 3 shows the following fact. That is, outputs from the logical circuits 211a and 211b (c≧2^{L-1}) to (c≧2⁰), in this case, (c≧2³) to (c≧2⁰) are “1” when logical values in ( ) are true, and the outputs are “0” when the logical values are false.

As is apparent from the logical values in FIG. 4B, the deciding circuit is designed such that, when the logical result (c≧2¹) is “1”, a logical result (c≧2⁰) must be “1” by the lower-bit control gate G1 in FIG. 4A.

In FIG. 4C, lower-bit control gates G2 and G3 are additionally connected to a 2-bit deciding circuit having the lower-bit control gate G1 in FIG. 4A in a laddery form to expand the 2-bit deciding circuit into a 4-bit deciding circuit.

More specifically, FIG. 4C shows that an H-bit deciding circuit and an H-bit deciding circuit are expanded by H OR logical elements to make it possible to constitute a 2H-bit deciding circuit.

The logical circuit in FIG. 3 constitutes two L-bit deciding circuits 211a and 211b by expanding the configuration in FIG. 4A like the configuration in FIG. 4C.

The logical circuit in FIG. 3 has the following configuration. That is, decision results of the deciding circuit 211b are further connected to one inputs of L OR logical elements constituting the lower-bit control gate 211c, and the other inputs of the L OR logical elements are commonly connected to each other and receive a least-significant deciding result of the logical circuit 211a.

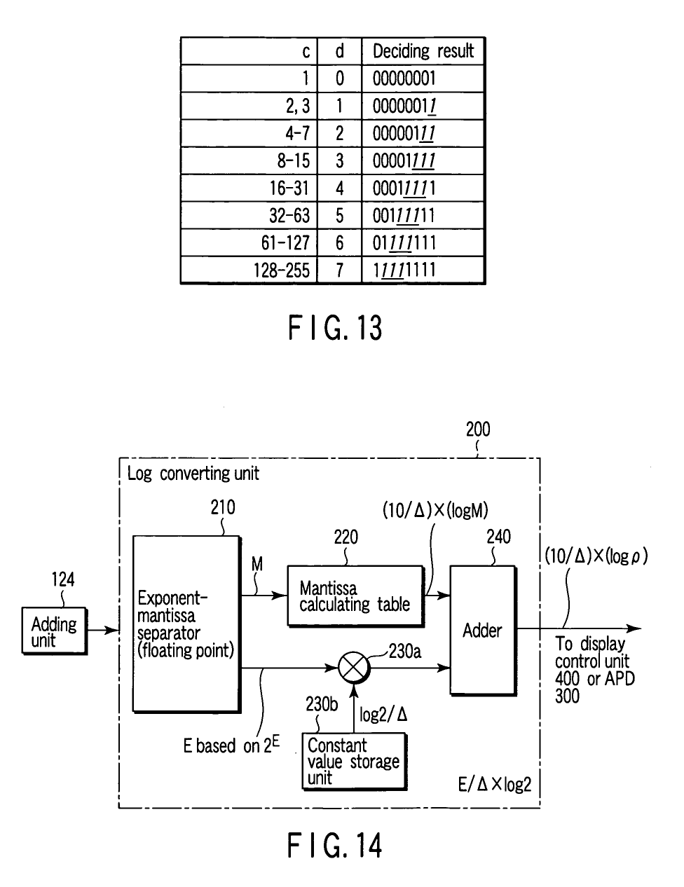

In this manner, the logical circuit in FIG. 3 constitutes a deciding circuit which decides a digit of the 2L-bit data ρ as a result. A logical value table of the deciding results is shown in FIG. 13.

For descriptive convenience, FIG. 13 shows an example about 8-bit data. “1” on the left end of a row “1” of the deciding result denotes a most-significant digit place.

“1” of three digits underlined is a bit constituting a mantissa part and a bit (position) selected by the mantissa selector 212 (however, bit data at the bit is selected from the data ρ).

The exponent determiner 213 in FIG. 2 is to convert a logical value representing a most-significant digit place output from the decider 211 into 5-bit data.

For example, when the most significant digit is a result of (c≧2³)=1, the exponent “3” is converted into 5-bit data “00011”. The data is output as data d expressing an exponent part.

As a concrete example of a method of converting the data expressing the exponent part, a binary tree multiplexer described in Patent Document 4 (Non-patent Documents 1 and 2) described above can be directly used. For this reason, an explanation of the method will be omitted.

The mantissa selector 212 selects 3-bit bit data following the most significant digit from the input data ρ and outputs the three bits as data m expressing the mantissa part.

As a concrete example of a method of selecting the data expressing the mantissa part, the binary tree multiplexer described in Patent Document 4 (Non-patent Documents 1 and 2) described above can be directly used. For this reason, an explanation of the method will be omitted.

(Simplification of Log Converting Unit 200).

In the log converting unit 200, data is converted into data in a floating-point format, and an exponent part and a mantissa part are separated from each other. The parts are input to two look-up tables (mantissa calculating table 220 and exponent calculating table 230) and converted into logarithms.

This contributes to simplification of the configuration of the log converting unit 200.

For example, when quadrature components I and Q in the IF detecting unit 120 are expressed by L=16-bit-signed integer (integer which is −2¹⁵ or more and 2¹⁵−1 or less), ρ=I²+Q² is a positive integer which is 2³¹ or less. For this reason, the value is expressed by a 32-bit positive integer (integer which is 0 or more and 2³²−1 or less).

At this time, when the resolution of a logarithm is set at 16 bits, a memory of 2³¹ words is required.

As described above, for example, the data is converted into floating-point type 13-bit data constituted by a 5-bit exponent part and an 8-bit mantissa part to obtain the following equation:
ρ=M2^{E}, M: {0, 1/ . . . 255}, E: {0, 1/ . . . 31}.
In this case, the value is expressed by:
10/Δ×Logρ=(10/Δ·LogM)+(3.010299/Δ·E).
The values of the first and second terms of the right-hand side are independently read from the look-up tables and added to each other, so that the log converting unit can be advantageously achieved by a memory of 256+32=285 words each of which is constituted by 16 bits.

This is very advantageous when a logical circuit to be used is constituted by an LSI.

When an error generated at this time is considered, it is understood that the error is expressed by the following equation with little trouble:
10Log(1+½⁸)=0.017 dB

When the error should be reduced, the number of bits of a mantissa may be increased.

### Second Embodiment

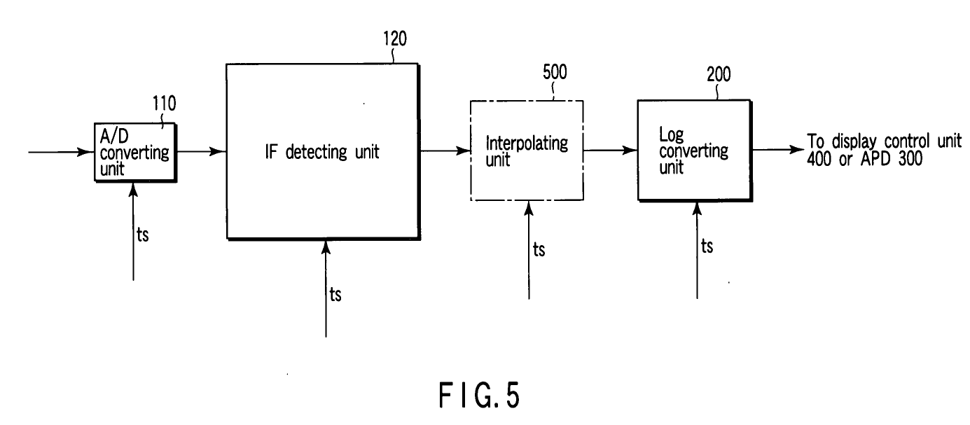

In the second embodiment, as shown in FIG. 5, an interpolating unit 500 is arranged between the IF detecting unit 120 and the log converting unit 200 in the first embodiment described above.

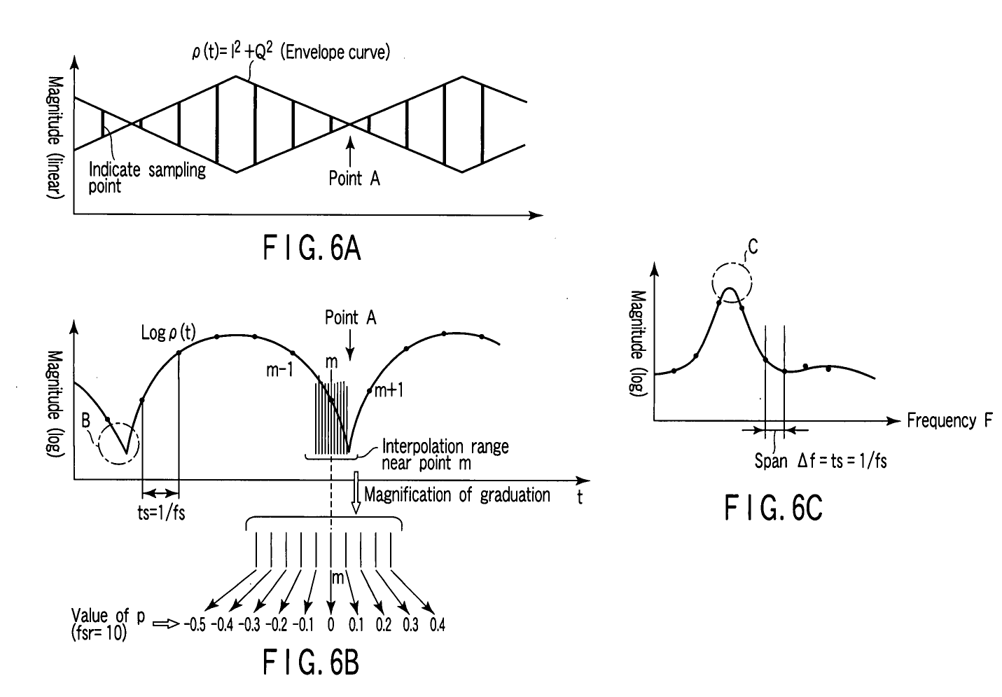

The necessity of the interpolating unit 500 will be described below with reference to FIGS. 6A, 6B, and 6C.

FIG. 6A shows a measurement data in a time domain. The ordinate indicates a magnitude (linear) of amplitude, and the abscissa indicates time.

A waveform shown in FIG. 6A is a waveform (ρ(t)=I²+Q²) obtained by receiving a high-frequency input signal having a triangular waveform and subjected to AM modulation and detecting the high-frequency input signal by the IF detecting unit 120, and exhibits an envelope curve of an AM-modulated wave.

When the waveform shown in FIG. 6A is subjected to log conversion, a waveform shown in FIG. 6B is obtained (In FIG. 6B, the ordinate indicates a log.).

When an amplitude becomes very small as indicated by a point A in FIG. 6A, an extremum which is sharply small as indicated by a point A in FIG. 6B is exhibited.

However, in fact, digitization causes data to be set between points (positions of black points in the drawings) of sampling performed by the A/D converting unit 110 every clock ts. For this reason, as shown by a portion B in FIG. 6B, the data is not measured without interpolation.

The sampling intervals ts on the abscissa in FIGS. 6A, 6B, and 6C are roughly displayed to help someone understand.

FIG. 6C is an exemplary measurement performed when the first embodiment is applied to a spectrum analyzer (will be described later in detail). The abscissa indicates a frequency, and the ordinate indicates a level (displayed by dB).

Also in this case, when a peak point of a certain electric wave is set in a sampling interval ts as indicated by a portion C in FIG. 6c, a frequency at this point may not be measured.

The interpolating unit 500 is to interpolate data in the sampling interval ts as described above based on data at sampling points near the sampling interval to obtain the data in the sampling interval ts.

The interpolation, for example, is to interpolate a range between −0.5 (ts) to +0.4 (ts) centering around a sampling point m (ts) at sampling intervals each of which is 1/10 the sampling interval ts, i.e., 0.1ts intervals, as shown in FIG. 6B.

When the interpolation is performed with respect to the sampling points, data at 0.1ts intervals can be obtained.

In this case, the ts/10 intervals are described. However, in general, interpolation can be performed at ts/2N(N is an integer) intervals.

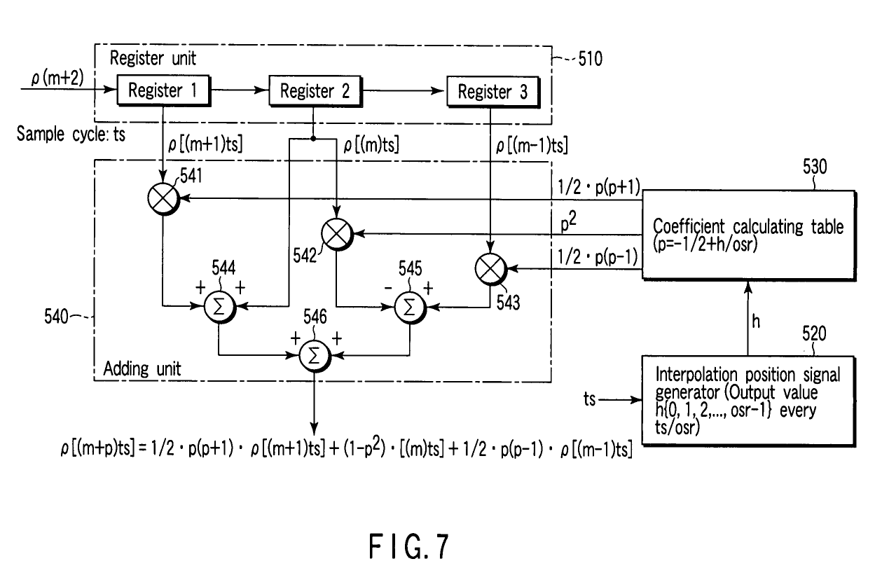

FIG. 7 shows a detailed circuit of the interpolating unit 500.

In a register unit 510 of the interpolating unit 500, data ρ[(m)ts] in the middle of an interpolation range to which interpolation is to be performed, data ρ[(m+1)ts] and ρ[(m−1)ts] which are closest thereto are temporarily stored in register 1, register 2, and register 3, respectively.

On the other hand, an interpolation position signal generator 520 generates interpolation timing signals h=0, 1, 2, 3, . . . , 9 at interpolation intervals expressed by ts/osr (osr: over sampling rate), for example, osr=10, every 0.1ts.

A coefficient calculating table 530 outputs, as p=−½+h/osr, coefficients of ½·p(p+1) and p², and ½·p(p−1).

By an adding unit 540 constituted by multiplexers 541, 542 and 543 and adders 544, 545 and 546, the following data ρ[(m+p)ts] is output.

$$\begin{matrix}ρ [ ( m + p ) ts ] = \frac{1}{2} . p ( p + 1 ) \cdot ρ [ ( m + 1 ) ts ] + ( 1 - {p}^{2} ) \cdot \\ [ ( m ) ts ] + \frac{1}{2} \cdot p ( p - 1 ) \cdot ρ [ ( m - 1 ) ts ]\end{matrix}$$

When osr=10 in the above equation, an interpolation interval is 0.1ts, an interpolation timing signal h=5, and p=0 is satisfied. As a result, ρ[(m+p)ts]=ρ[(m)ts] is satisfied.

More specifically, it is possible to acquire data ρ at interpolation points (see graduation points understandably enlarged) of −0.5(ts) to +0.4(ts) centered about a point m(ts) in FIG. 6B.

As a method of using the interpolating unit 500, the following method can also be used in addition to the above using method. That is, for example, although conventional measurement is performed at intervals ts, measurement is performed at 10ts intervals (clock of the A/D converting unit 110 is set at 10ts) to make it possible to obtain interpolated data at intervals ts.

In this case, a processing load of the RBW 122 constituted by a digital filter can be reduced.

As a matter of course, in this case, it must be satisfied that data to be interpolated continues at the 10ts intervals.

### Third Embodiment

A third embodiment is an embodiment in which the log converting unit 200, the interpolating unit 500, and the APD 300 in the above description are applied to a signal analyzing apparatus, for example, a spectrum analyzer.

FIG. 10 is a block diagram showing a configuration of a spectrum analyzer applied as a signal analyzing apparatus according to the third embodiment.

In FIG. 10, parts indicated by the same reference numerals as in FIGS. 1 and 5 have the same functions in FIGS. 1 and 5.

Most of the contents of the first and second embodiments can be applied to the third embodiment.

In FIG. 10, a high-frequency (RF) unit 900 is a receiving unit which converts an input RF signal having a frequency f_{RF} into a predetermined intermediate-frequency signal f_{IN} while sweeping the input RF signal over a predetermined frequency range, thereby selectively receiving the input RF signal.

The sweeping unit 900c receives information representing a frequency range (this range is called a “frequency span”) from an fst (start frequency) to an fsp (stop frequency) by a designation from a sequential control unit 800, and sweeps the oscillation frequency of a local signal oscillator (OSC) 900b from (fst+f_{IN}) to (fsp+f_{IN}) for sweeping time tspan.

A mixer unit 900a receives an input RF signal, mixes the input RF signal with a local signal from the local signal OSC 900b, and outputs the intermediate-frequency signal f_{IN} to an A/D converting unit 110.

The A/D converting unit 110 outputs L=tspan/ts digital data at clock ts intervals per sweeping operation.

In this case, a frequency interval per cycle ts is given by (fst−fsp)/L (Hz).

The sequential control unit 800 receives a desired frequency span range (frequency span) to be measured and desired sweeping time tspan to sweep the frequency span from an operation unit (not shown) on a panel and determines a clock cycle ts or the like, so that operation timings of respective parts are controlled.

An output from the A/D converting unit 110 is limited in bandwidth to a resolution bandwidth by an IF detecting unit 120 and squared and then output.

The interpolating unit 500 outputs data obtained by interpolating and approximating a squared-detection waveform output from the IF detecting unit 120 at, for example, 0.1ts intervals (osr=10).

In this case, data obtained at ts intervals are obtained as a matter of course.

By interpolated approximation, data having a fineness of (fst−fsp)/10L (Hz) in terms of a frequency interval can be obtained.

As the output from the interpolating unit 500, an amplitude (level) is log-converted by the log converting unit 200, and the log-converted amplitude is stored in a storage unit 700 at intervals of frequencies of (fst−fsp)/10L (Hz).

Data is read from the storage unit 700 and displayed on a display unit 600 as shown in, for example, FIG. 11.

In this case, the display control unit 400 receives frequency information (or corresponding time information ts or 0.1ts) of the abscissa in FIG. 11 from the sequential control unit 800.

A spectrum waveform shown on the lower side in FIG. 11 is obtained such that spectra in a frequency span (fst−fsp) on the abscissa are plotted on the ordinate in units of dBm.

In this case, the abscissa is connected by an envelope curve. However, in fact, the abscissa is, for example, data of 512 points, a frequency interval of the points is (fst−fsp)/L (Hz), and ts is set as a time interval.

A dotted-line frame D on the lower side in FIG. 11 is obtained such that a delta marker (marker having a variable width and a variable position) designated by operating means (not shown) on the panel is generated and displayed by the display control unit 400.

A spectrum display on the upper side in FIG. 11 is obtained such that the display control unit 400 reads data obtained at intervals of (fst−fsp)/10L (Hz) in a frequency range of f1 to f2 corresponding to the width of the delta marker designated by the panel from the storage unit 700 and magnified and displayed at 512 points on the same abscissa.

In a conventional spectrum analyzer, sweeping measurement is performed in a frequency span fst−fsp. Thereafter, sweeping measurement is performed in a frequency span f1−f2. More specifically, sweeping measurement is performed two times, so that the same display as that of the spectrum display on the upper side in FIG. 11 can be performed.

However, in the third embodiment, the display can be achieved by performing sweeping measurement once in a frequency span fst−fsp by means of the interpolating unit 500.

The APD 300 performs sweeping measurement in the frequency span fst−fsp the number of times required for a hour rate, so that an amplitude probability including a frequency of the interval of (fst−fsp)/L (Hz) or the interval of (fst−fsp)/10L (Hz) as a parameter is calculated and output.

The display control unit 400 receives a calculation result of the APD 300 to cause the display unit 600 to perform a display shown in FIG. 12 or a display shown in FIG. 8B.

On the abscissa in FIG. 8B, in place of f_{IN1}, f_{IN2}, . . . , for example, the interval of (fst−fsp)/L (Hz) including the frequency fst as a start is set.

More specifically, therefore, frequency components of an input RF signal and an interference wave and a distribution of an amplitude probability (time rate) can be measured and displayed as shown in FIG. 12.

FIGS. 10 and 11 can also be applied to not only a spectrum analyzer but also a network analyzer or the like which transmits a signal to a network and receives a signal from the network to analyze the network.

The present invention can be applied to anything that converts, for example, rotation, vibration, or the like into an electric signal to measure the magnitude of the rotation, the vibration, or the like or converts the rotation, the vibration, or the like into a logarithm.

Therefore, according to the present invention described above, in order to solve the problems of the conventional technique, a technique which can obtained preferable log characteristics at a high speed by a digitally hardware configuration, for example, a logical circuit is employed, and a technique which calculates digital data set in a sampling interval by interpolation is employed. Consequently, a signal measuring/analyzing apparatus and a signal measuring/analyzing method such as amplitude probability measurement or a spectrum analyzer which has a minimum memory capacity and can achieve high-speed processing can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A signal measuring apparatus comprising:
a data converting unit which converts an input signal into digital data having a predetermined number of bits with clocks having a predetermined cycle ts and performs squared detection of the digital data to output the resultant data as phase-detected data;
an exponent-mantissa separator which receives the phase-detected data output from the data converting unit and separates the phase-detected data into mantissa data expressing a mantissa part of the phase-detected data and exponent data expressing an exponent part of the phase-detected data to output the mantissa data and the exponent data;
a mantissa calculating table which is accessed by the mantissa data output from the exponent-mantissa separator and which outputs a logarithm corresponding to the mantissa data stored in advance;
an exponent output unit which outputs a logarithm corresponding to the exponent data based on the exponent data output from the exponent-mantissa separator; and
an adder which, in order to obtain an output logarithm corresponding to the amplitude of the input signal, adds the logarithm corresponding to the mantissa data output from the mantissa calculating table to the logarithm corresponding to the exponent data output from the exponent output unit and outputs an output logarithm corresponding to the phase-detected data.

2. The signal measuring apparatus according to claim 1, wherein
the exponent output unit comprises:
an exponent calculating table which is accessed by the exponent data output from the exponent-mantissa separator and which outputs a logarithm corresponding to the exponent data stored in advance.

3. The signal measuring apparatus according to claim 1, wherein
the exponent-mantissa separator comprises:
a decider which receives the phase-detected data output from the data converting unit, discriminates a most significant bit of the phase-detected data in when receiving by using a logical circuit, and outputs a discrimination result;
a mantissa selector which selects data of a plurality of bits including data of a predetermined number of lower bits from the discrimination result of the most significant bit output from the decider and outputs the data as mantissa data expressing the mantissa part based on plurality of selected bit data; and
an exponent determiner which converts the most significant bit into identifiable identification data based on the discrimination result of the most significant bit output from the decider and outputs the identification data as the exponent data expressing the exponent part.

4. The signal measuring apparatus according to claim 1, further comprising:
an interpolating unit inserted between the data converting unit and the mantissa-exponent separator, the interpolating unit receiving the clocks having the predetermined cycle ts, interpolating the phase-detected data output from the data converting unit at an interval of 1/N in the predetermined cycle ts, and transmitting an interpolated value to the exponent-mantissa separator.

5. The signal measuring apparatus according to claim 4, wherein
the interpolating unit is configured to designate phase-detected data at a center (mts) of a range to be interpolated by the phase-detected data output at intervals of 1/N in the predetermined cycle ts, generate an extraction signal (mts±p, p is an integer ranging from 0 to N/2) having a cycle ts/N in the range to be interpolated, weight the phase-detected data {ρ(mts)} at the center of the range to be interpolated and nearest phase-detected data {ρ((m−1)ts), ρ((m+1)ts)} corresponding to width (±p) of a space between the extraction signal and the center in the range to be interpolated, and generate the interpolated value every extraction signal based on weighted values.

6. The signal measuring apparatus according to claim 1, wherein
the data converting unit comprises:
an analog/digital (A/D) converting unit which converts the input signal into digital data having the predetermined number of bits with the clocks having the predetermined cycle ts;
a quadrature detecting unit which performs a mixing operation to each component obtained by branching an output from the A/D converting unit into two components independently of two local signals having phases different from each other by 90° and each having a predetermined frequency and outputs two quadrature components having phases orthogonalized at a frequency corresponding to a difference between the frequency of the input signal and the predetermined frequency;
a resolution bandwidth (RBW) filter unit which performs predetermined bandwidth limitation to the two quadrature components output from the quadrature detecting unit and outputs two bandwidth limitation resultant quadrature components;
a square detecting unit which performs square detection to the two bandwidth limitation resultant quadrature components output from the RBW filter unit and outputs two square detection resultant quadrature components; and
an adding unit which adds the two square detection resultant quadrature components output from the square detecting unit.

7. The signal measuring apparatus according to claim 1, further comprising:
an amplitude probability measuring unit, the amplitude probability measuring unit comprising:
a memory which is accessed by using the output logarithm output from the adder as an address value (k) and which outputs data corresponding to the output logarithm stored in advance to the address;
a data converter which receives data {Gⁿ⁻¹(k): n is the number of times of access up to the previous access} at the address output from the memory, converts the data into data {Gⁿ(k)} including information expressing the number of times of the latest access, and stores the data at identical address in the memory;
a frequency extracting unit which receives the latest data Gⁿ(k) output from the memory, converts the data into the number of times {n(k)} of access performed to addresses by the output logarithm, and outputs the number of times; and
an amplitude probability calculating unit which calculates an amplitude probability based on the number of times {n(k)} of access performed by the output logarithm output from the frequency extracting unit and outputs the amplitude probability.

8. A signal analyzing apparatus comprising:
an RF unit which sweeps a desired frequency bandwidth to an input high-frequency (RF) signal, and thereby converts the input RF signal selectively received into a predetermined intermediate-frequency (IF) signal and outputs the IF signal;
an A/D converting unit which analog/digital-converts the IF signal output from the RF unit at clocks generated in the predetermined cycle ts and outputs the digital signal as digital data having a predetermined number of bits;
an IF detecting unit comprising:
a quadrature detecting unit which performs a mixing operation to each component obtained by branching an output from the A/D converting unit into two components independently of two local signals having phases different from each other by 90° and each having a predetermined frequency and outputs two quadrature components having phases orthogonalized at a frequency corresponding to a difference between the frequency of the input signal and the predetermined frequency;
a resolution bandwidth (RBW) filter unit which performs predetermined bandwidth limitation to the two quadrature components output from the quadrature detecting unit and outputs two bandwidth limitation resultant quadrature components;
a square detecting unit which performs square detection to the two bandwidth limitation quadrature components output from the RBW filter unit and outputs two square detection resultant quadrature components; and
an adding unit which adds the two square detection resultant quadrature components output from the square detecting unit and outputs phase-detected data;
a log converting unit comprising:
an exponent-mantissa separator which receives the phase-detected data output from the adding unit of the IF detecting unit and separates the phase-detected data into mantissa data expressing a mantissa part of the phase-detected data and exponent data expressing an exponent part of the phase-detected data to output the mantissa data and the exponent data;
a mantissa calculating table which is accessed by the mantissa data output from the exponent-mantissa separator and which outputs a logarithm corresponding to the mantissa data stored in advance;
an exponent output unit which outputs a logarithm corresponding to the exponent data based on the exponent data output from the exponent-mantissa separator; and
an adder which adds the logarithm corresponding to the mantissa data output from the mantissa calculating table to the logarithm corresponding to the exponent data output from the exponent output unit and outputs a logarithm corresponding to the phase-detected data; and
a display control unit which displays the logarithm corresponding to the phase-detected data output from the adder of the log converting unit on a display unit.

9. The signal analyzing apparatus according to claim 8, wherein
the exponent output unit comprises:
an exponent calculating table which is accessed by the exponent data output from the exponent-mantissa separator and which outputs a logarithm corresponding to the exponent data stored in advance.

10. The signal analyzing apparatus according to claim 8, further comprising:
an amplitude probability measuring unit,
the amplitude probability measuring unit comprising:
a memory which is accessed by using the output logarithm output from the adder of the log converting unit as an address value (k) and which outputs data corresponding to the output logarithm stored in advance to the address;
a data converter which receives data {Gⁿ⁻¹(k): n is the number of times of access up to the previous access} at the address output from the memory, converts the data into data {Gⁿ(k)} including information expressing the number of times of the latest access, and stores the data at identical address in the memory;
a frequency extracting unit which receives the latest data Gⁿ(k) output from the memory, converts the data into the number of times {n(k)} of access performed to addresses by the output logarithm, and outputs the number of times; and
an amplitude probability calculating unit which calculates an amplitude probability of the input RF signal selectively received by the RF unit based on the number of times {n(k)} of access performed by the output logarithm output from the frequency extracting unit, and outputs the amplitude probability, wherein
the display control unit is configured to cause the display unit to selectively display the logarithm corresponding to the phase-detected data output from the adder of the log converting unit or the amplitude probability output from the amplitude probability calculating unit of the amplitude probability measuring unit on coordinates taking the abscissa of which indicates frequencies in the desired frequency bandwidth.

11. The signal analyzing apparatus according to claim 10, further comprising:
an interpolating unit inserted between the IF detecting unit and the log converting unit, the interpolating unit for receiving the clocks having the predetermined cycle ts, interpolating the phase-detected data output from the adder of the IF detecting unit at an interval of 1/N in the predetermined cycle ts, and transmitting an interpolated value to the exponent-mantissa separator of the log converting unit, wherein
the display control unit is configured to selectively display the logarithm depending on the phase-detected data output from the adder of the log converting unit or the amplitude probability output from the amplitude probability calculating unit of the amplitude probability measuring unit such that the frequencies in the desired frequency bandwidth on the abscissa are displayed by any of frequencies corresponding to an interval of the predetermined cycle ts and frequencies corresponding to an interval of a cycle ts/N.

12. The signal analyzing apparatus according to claim 11, wherein
the display control unit is configured to selectively display the logarithm corresponding to the phase-detected data output from the adder of the log converting unit or the amplitude probability output from the amplitude probability calculating unit of the amplitude probability measuring unit such that the frequencies in the desired frequency bandwidth on the abscissa are displayed by frequencies corresponding to an interval of the predetermined cycle ts and some of the frequencies are magnified and displayed by the frequencies corresponding to the interval of the cycle ts/N.

13. The signal analyzing apparatus according to claim 11, wherein
the interpolating unit is configured to designate phase-detected data at a center (mts) of a range to be interpolated by the phase-detected data output at intervals of 1/N in the predetermined cycle ts, generate an extraction signal (mts±p, p is an integer ranging from 0 to N/2) having a cycle ts/N in the range to be interpolated, weight the phase-detected data {ρ(mts)} at the center of the range to be interpolated and nearest phase-detected data {ρ((m−1)ts), ρ((m+1)ts)} corresponding to width (±p) of a space between the extraction signal and the center in the range to be interpolated, and generate the interpolated value every extraction signal based on weighted values.

14. The signal analyzing apparatus according to claim 8, wherein
the exponent-mantissa separator comprises:
a decider which receives the phase-detected data output from the adding unit of the IF detecting unit, discriminates a most significant bit of the received phase-detected data in when receiving by using a logical circuit, and outputs a discrimination result;
a mantissa selector which selects data of a plurality of bits including data of a predetermined number of lower bits from the discrimination result of the most significant bit output from the decider and outputs the data as mantissa data expressing the mantissa part based on plurality of selected bit data; and
an exponent determiner which converts the most significant bit into identifiable identification data based on the discrimination result of the most significant bit output from the decider and outputs the identification data as exponent data expressing the exponent part.

15. A signal measuring method comprising the steps of:
preparing a data converting unit, an exponent-mantissa separator, a mantissa calculating table, an exponent output unit, and an adder;
causing the data converting unit to convert an input signal into digital data having a predetermined number of bits at clocks having a predetermined cycle ts and to perform squared detection of the digital data to output phase-detected data;
causing the exponent-mantissa separator to receive the phase-detected data and to separate the phase-detected data into mantissa data expressing a mantissa part of the phase-detected data and exponent data expressing an exponent part of the phase-detected data to output the mantissa data and the exponent data;
outputting an output logarithm corresponding to the mantissa data stored in advance from the mantissa calculating table to be accessed by the mantissa data;
causing the exponent output unit to output a logarithm corresponding to the exponent data based on the exponent data output from the exponent-mantissa separator; and
causing the adder to, in order to obtain an output logarithm corresponding to the amplitude of the input signal, add the logarithm corresponding to the mantissa data to the logarithm corresponding to the exponent data and output an output logarithm corresponding to the phase-detected data.

16. The signal measuring method according to claim 15, wherein
the exponent output unit comprises:
an exponent calculating table which is accessed by the exponent data output from the exponent-mantissa separator and which outputs a logarithm corresponding to the exponent data stored in advance.

17. The signal measuring method according to claim 15, wherein
the exponent-mantissa separator comprises:
a decider which receives the phase-detected data output from the data converting unit, discriminates a most significant bit of the phase-detected data in when receiving by using a logical circuit, and outputs a discrimination result;
a mantissa selector which selects data of a plurality of bits including data of a predetermined number of lower bits from the discrimination result of the most significant bit output from the decider and outputs the data as mantissa data expressing the mantissa part based on the plurality of selected bit data; and
an exponent determiner which converts the most significant bit into identifiable identification data based on the discrimination result of the most significant bit output from the decider and outputs the identification data as exponent data expressing the exponent part.

18. The signal measuring method according to claim 15, further comprising the steps of:
preparing an interpolating unit; and
causing the interpolating unit to receive the clocks having the a predetermined cycle ts, interpolate the phase-detected data output from the data converting unit at an interval of 1/N in the predetermined cycle ts, and transmit an interpolated value to the exponent-mantissa separator.

19. The signal measuring method according to claim 18, wherein
the interpolating unit is configured to designate phase-detected data at a center (mts) of a range to be interpolated by the phase-detected data output at intervals of 1/N in the predetermined cycle ts, generate an extraction signal (mts±p, p is an integer ranging from 0 to N/2) having a cycle ts/N in the range to be interpolated, weight the phase-detected data {ρ(mts)} at the center of the range to be interpolated and nearest phase-detected data {ρ((m−1)ts), ρ((m+1)ts)} corresponding to width (±p) of a space between the extraction signal and the center in the range to be interpolated, and generate the interpolated value every extraction signal based on a weighted values.

20. The signal measuring method according to claim 15, wherein
the data converting unit comprises:
an analog/digital (A/D) converting unit which converts the input signal into digital data having the predetermined number of bits with clocks having the predetermined cycle ts;
a quadrature detecting unit which performs a mixing operation to each component obtained by branching an output from the A/D converting unit into two components independently of two local signals having phases different from each other by 90° and each having a predetermined frequency and outputs two quadrature components having phases orthogonalized at a frequency corresponding to a difference between the frequency of the input signal and the predetermined frequency;
a resolution bandwidth (RBW) filter unit which performs predetermined bandwidth limitation to the two quadrature components output from the quadrature detecting unit and outputs two bandwidth limitation resultant quadrature components;
a square detecting unit which performs square detection to the two quadrature components output from the RBW filter unit and outputs two square detection resultant quadrature components; and
an adding unit which adds the two square detection quadrature components output from the square detecting unit.

21. The signal measuring method according to claim 15, further comprising the steps of:
preparing an amplitude probability measuring unit comprising a memory, a data converter, a frequency extracting unit, and an amplitude probability calculating unit;
outputting data corresponding to the output logarithm stored in advance to the address from the memory which is accessed by using the output logarithm output from the adder as an address value (k);
causing the data converter to receive data {Gⁿ⁻¹(k): n is the number of times of access up to the previous access} at the address output from the memory, convert the data into data {Gⁿ(k)} including information expressing the number of times of the latest access, and store the data at identical address in the memory;
causing the frequency extracting unit to receive the latest data Gⁿ(k) output from the memory and convert the data into the number of times {n(k)} of access performed to addresses by the output logarithm to output the number of times; and
causing the amplitude probability calculating unit to calculate an amplitude probability based on the number of times {n(k)} of access performed by the output logarithm and output the amplitude probability.

22. A signal analyzing method comprising the steps of:
preparing a high-frequency (RF) unit, an analog/digital (A/D) converting unit, an IF detecting unit, a log converting unit, a display unit, and a display control unit;
causing the RF unit to sweep a desired frequency bandwidth to an input high-frequency (RF) signal, and thereby to convert the input RF signal selectively received into a predetermined intermediate-frequency (IF) signal and output the IF signal;
causing the A/D converting unit to analog/digital-convert the IF signal with the clocks having the predetermined cycle ts and output digital data having a predetermined number of bits;
preparing the IF detecting unit comprising a quadrature detecting unit, a resolution bandwidth (RBW) filter unit, a square detecting unit, and an adding unit;
causing the quadrature detecting unit to perform a mixing operation to each component obtained by branching an output from the A/D converting unit into two components independently of two local signals having phases different from each other by 90° and each having a predetermined frequency and output two quadrature components having phases orthogonalized at a frequency corresponding to a difference between the frequency of the input signal and the predetermined frequency;
causing the RBW filter unit to perform predetermined bandwidth limitation to the two quadrature components and output two bandwidth limitation resultant quadrature components;
causing the square detecting unit to perform square detection to the two quadrature components subjected to the bandwidth limitation and output two square detection resultant quadrature components;
causing the adding unit to add the two square detection resultant quadrature components output from the square detecting unit and output phase-detected data;
preparing the log converting unit comprising an exponent-mantissa separator, a mantissa calculating table, an exponent output unit, and an adder;
causing the exponent-mantissa separator to receive the phase-detected data and separate the phase-detected data into mantissa data expressing a mantissa part of the phase-detected data and exponent data expressing an exponent part of the data and output the mantissa data and the exponent data;
outputting a logarithm corresponding to the mantissa data stored in advance from the mantissa calculating table which is accessed by the mantissa data;
causing the exponent output unit to output a logarithm corresponding to the exponent data based on the exponent data;
causing the adder to add the logarithm corresponding to the mantissa data output from the mantissa calculating table to the logarithm corresponding to the exponent data output from the exponent output unit and output an output logarithm corresponding to the phase-detected data; and
causing the display control unit to display the output logarithm corresponding to the phase-detected data on the display unit.

23. The signal analyzing method according to claim 22, wherein
the exponent output unit comprises:
an exponent calculating table which is accessed by the exponent data output from the exponent-mantissa separator and which outputs a logarithm corresponding to the exponent data stored in advance.

24. The signal analyzing method according to claim 22, further comprising the steps of:
preparing an amplitude probability measuring unit comprising a memory, a data converter, a frequency extracting unit, and an amplitude probability calculating unit;
outputting data corresponding to the output logarithm stored in advance to the address from the memory which is accessed by using the output logarithm as an address value (k);
causing the data converter to receive data {Gⁿ⁻¹(k): n is the number of times of access up to the previous access} at the address output from the memory, convert the data into data {Gⁿ(k)} including information expressing the number of times of the latest access, and store the data at identical address in the memory;
causing the frequency extracting unit to receive the latest data Gⁿ(k) output from the memory, convert the data into the number of times {n(k)} of access performed to addresses by the output logarithm, and output the number of times; and
causing the amplitude probability calculating unit to calculate an amplitude probability based on the output of the number of times {n(k)} of access performed by the output logarithm.

25. The signal analyzing method according to claim 22, further comprising the steps of:
preparing an interpolating unit;
causing the interpolating unit to receive the clocks having the predetermined cycle ts, interpolate the phase-detected data output from the data converting unit at an interval of 1/N in the predetermined cycle ts, and transmit an interpolated value to the exponent-mantissa separator; and
causing the display control unit to selectively display the logarithm corresponding to the phase-detected data or the amplitude probability such that the frequencies in the desired frequency bandwidth on the abscissa are displayed by any of frequencies corresponding to an interval of the predetermined cycle ts and frequencies corresponding to an interval of a cycle ts/N.

26. The signal analyzing method according to claim 25, wherein
the display control unit is configured to selectively display the logarithm corresponding to the phase-detected data or the amplitude probability such that the frequencies in the desired frequency bandwidth on the abscissa are displayed by frequencies corresponding to an interval of the predetermined cycle ts and some of the frequencies are magnified and displayed by the frequencies corresponding to the interval of the cycle ts/N.

27. The signal analyzing method according to claim 25, wherein
the interpolating unit is configured to designate phase-detected data at a center (mts) of a range to be interpolated by the phase-detected data output at intervals of 1/N in the predetermined cycle ts, generate an extraction signal (mts±p, p is an integer ranging from 0 to N/2) having a cycle ts/N in the range to be interpolated, weight the phase-detected data {ρ(mts)} at the center of the range to be interpolated and nearest phase-detected data {ρ((m−1)ts), ρ((m+1)ts)} corresponding to width (±p) of a space between the extraction signal and the center in the range to be interpolated, and generate the interpolated value every extraction signal based on weighted values.

28. The signal analyzing method according to claim 22, wherein
the exponent-mantissa separator comprises:
a decider which receives the phase-detected data output from the adding unit of the IF detecting unit, discriminates a most significant bit of the received phase-detected data by a logical circuit, and outputs a discrimination result;
a mantissa selector which selects data of a plurality of bits including data of a predetermined number of lower bits from the discrimination result of the most significant bit output from the decider and outputs the data as mantissa data expressing the mantissa part based on plurality of selected bit data; and
an exponent determiner which converts the most significant bit into identifiable identification data based on the discrimination result of the most significant bit output from the decider and outputs the identification data as exponent data expressing the exponent part.
